(19) United States
(12) Patent Application Publication
(10) Pub. No.: US 2015/0344173 A1
(43) Pub. Date: Dec. 3, 2015

(54) VACUUM HEAT INSULATION MATERIAL, HEAT INSULATION BOX COMPRISING SAME, AND METHOD FOR MANUFACTURING VACUUM HEAT INSULATION MATERIAL

(71) Applicant: Panasonic Intellectual Property Management Co., Ltd., Osaka-shi, Osaka (JP)

(72) Inventors: Shinya KOJIMA, Kyoto (JP); Toshio KOBAYASHI, Kyoto (JP)

(21) Appl. No.: 14/654,013

(22) PCT Filed: Dec. 19, 2013
(86) PCT No.: PCT/JP2013/007456

§ 371 Date: Jun. 19, 2015

(30) Foreign Application Priority Data
Dec. 20, 2012 (JP) 2012-277766
Dec. 20, 2012 (JP) 2012-277774

(51) Int. Cl. B65D 6/00; B32B 3/06; B32B 7/12; B29C 65/00; B32B 37/06; B32B 37/10; B32B 37/18; B32B 1/02; B29C 65/20

(52) U.S. Cl. CPC B65D 11/10; B32B 1/02; B32B 3/06; B32B 7/12; B65D 11/20; B29C 65/20; B32B 37/06; B32B 37/10; B32B 37/182; B29C 66/301; B32B 2307/304; B32B 2307/31; B32B 2439/00; B29K 2677/00

(57) ABSTRACT

The vacuum insulation panel according to the present invention includes: a core material (2) containing an inorganic fiber, a first film laminate (4a) having a first heat-sealing layer (5a) on the joining side, and a second film laminate (4b) having a second heat-sealing layer (5b) on the joining side, the density of the first heat-sealing layer (5a) being lower than the density of the second heat-sealing layer (5b).

### TECHNICAL FIELD

The present invention relates to a vacuum insulation panel, a heat-insulating box including the vacuum insulation panel, and a method for producing a vacuum insulation panel.

### BACKGROUND ART

In recent years, efforts have been actively made to promote energy conservation to address global warming, which is an issue of global environment. Particularly in apparatuses that employ heating and cooling, vacuum insulation panels excellent in insulation are achieving widespread use from the viewpoint of effective use of heat.

A vacuum insulation panel is prepared by forming a bag with two film laminates having gas barrier properties and, in the bag, placing a core material having a high volume ratio of gas phase and having minute gaps, such as a glass fiber and a silica powder, followed by hermetically enclosing the core material under reduced pressure.

When the diameter of the gaps formed by the core material is smaller than the mean free path of the molecule of gas under reduced pressure, the gas has low thermal conductivity. When the diameter of the gaps is as small as about 1 mm, the influence of convection heat transfer is negligible. Besides, at near room temperature, the influence of radiation components is very small and therefore thermal conduction of the vacuum insulation panel is attributable to heat transfer within solid of the core material and thermal conduction in a minimal amount of gas remaining in the gaps, allowing the vacuum insulation panel to have significantly high insulating effect compared with the insulating effect of a normal-pressure insulating panel such as urethane foam and glass wool.

For the purpose of maintaining the depressurized state within the gaps formed by the core material, the film laminate is composed of a gas barrier film for preventing permeation of gas or water vapor, a protective film for protecting one side of the gas barrier film, and a heat-sealing film provided on the other side of the gas barrier film for use to form the film laminate into a bag shape.

The vacuum insulation panel having this configuration, however, allows permeation of gas or water vapor from the atmosphere through the heat-sealing film or the gas barrier film to reduce the degree of vacuum inside the vacuum insulation panel and, as a result, becomes greatly affected by thermal conduction of gas. Because of this, the insulating effect of the vacuum insulation panel deteriorates year after year, which presents a problem.

For the purpose of solving the problem, a vacuum insulation panel is developed which is prepared by enclosing an insulation core material in a packaging bag, the bag being formed of a multilayered film composed of a polyethylene terephthalate film layer, a nylon film layer, an aluminum foil layer, and a high-density polyethylene film layer and a multilayered film composed of a barrier film layer having a plurality of inorganic oxide-deposited layers, a nylon film layer, a barrier film layer having a plurality of inorganic oxide-deposited layer, and a high-density polyethylene film layer, the bag having the high-density polyethylene film layers on its interior side, and then hermetically seal a heat-insulating core panel in the bag to create a vacuum inside the bag (see PTL 1, for example).

For the purpose of solving the problem, another vacuum heat-insulating panel is developed which is prepared by forming exterior skins from a film having a gas barrier layer and an adhesive layer, and bonding one piece of the adhesive layer to another piece of the adhesive layer at sealing parts of the exterior skins to form a bonding portion part of which is thinned to form a thinned streak (see PTL 2, for example).

FIG. 14 is a sectional view of the vacuum heat-insulating panel disclosed in PTL 2. FIG. 15 is a sectional view of a sealing jig used to produce the vacuum heat-insulating panel shown in FIG. 14.

As shown in FIG. 14, the vacuum heat-insulating panel 101 disclosed in PTL 2 includes an outer skin member 104 having a gas barrier layer 102 and an adhesive layer 103, and, at the sealing part of the outer skin member 104, part of the adhesive layer 103 is thinned to form a thinned streak 105. The thinned streak 105 is formed on the entire circumference of the outer skin member 104 by pressing part of the outer skin member 104 of the sealing part particularly strongly using a sealing jig 106 shown in FIG. 15.

### CITATION LIST

### Patent Literature

PTL 1: JP 4649969 B1

PTL 2: JP S62-141190 Y

### SUMMARY OF INVENTION

### Technical Problem

High-density polyethylene is inferior to low-density polyethylene in terms of sealing properties to resist foreign matter. Therefore, when a chip of a fibrous core material, if used together with high-density polyethylene, is heat sealed together with a heat-sealing film, the chip of the core material may not be thoroughly covered with the heat-sealing film. Because of this, the vacuum insulation panel disclosed in PTL 1 where high-density polyethylene film layers are provided in both of the two film laminates can allow gas or water vapor to easily enter through gaps between the chip of the core material and the heat-sealing film, which presents a problem, referred to as a first problem.

High-density polyethylene is inferior to low-density polyethylene in terms of flexibility as well.

Therefore, when a core material made of a glass fiber is used, a lump of unfiberized glass may pierce the film laminate to readily form a through hole. Because of this, the vacuum insulation panel disclosed in PTL 1 may allow gas or water vapor to enter through the through hole, which presents a problem, referred to as a second problem.

In the case of the vacuum heat-insulating panel disclosed in PTL 2, the sealing jig 106 having a sharply-edged protrusion is used for pressing during production as shown in FIG. 15 and, as a result, a sharp edge 107 may form in the thinned streak 105. The sharp edge 107, if formed, in the thinned streak 105 may cause cracks and allow atmospheric gas components to easily enter the vacuum heat-insulating panel 101 through the cracks over time, which presents a problem, referred to as a third problem.

Particularly in the vacuum heat-insulating panel disclosed in PTL 2, the protrusion is arranged to face another as viewed from the thickness direction of the vacuum heat-insulating panel and therefore the thinned streak 105 tends to have the sharp edge 107.

The sharp edge 107 herein refers to a sharply-edged part (a part having great curvature), as seen in a cross section of the sealing part taken from a plane parallel to the thickness direction of the outer skin member 104, that is formed on the boundary or near the boundary of the thinned streak 105 where the thickness of the adhesive layer 103 changes.

An object of the present invention is to provide a vacuum insulation panel, a heat-insulating box including the vacuum insulation panel, and a method for producing a vacuum insulation panel, for solving at least one of the first to the third problems.

### Solution to Problem

In order to achieve the object, the vacuum insulation panel of the present invention includes:
a core material containing an inorganic fiber,
a first film laminate having a first heat-sealing layer on the joining side, and
a second film laminate having a second heat-sealing layer on the joining side,
the density of the first heat-sealing layer being lower than the density of the second heat-sealing layer.

By this configuration in which the heat-sealing layers of the facing film laminates have different density, the first heat-sealing layer having lower density can give, to the vacuum insulation panel, sealing properties to resist foreign matter and pinhole resistance to prevent glass from making pinholes, while the second heat-sealing layer having higher density can provide effect, for example, to regulate the amount of gas or water vapor entering the vacuum insulation panel.

As described above, in the vacuum insulation panel of the present invention, the first film laminate having the first heat-sealing layer with relatively low density can provide improvement in the sealing properties to resist foreign matter and the pinhole resistance, while the second film laminate having the second heat-sealing layer with relatively high density can regulate the amount of gas or water vapor entering the vacuum insulation panel so as to maintain the insulating effect at a high level for an extended period of time.

The heat-insulating box of the present invention includes:
the vacuum insulation panel,
an outer casing, and
an inner casing, in which
the non-joining side of the first laminate or the second laminate of the vacuum insulation panel is fixed to a surface of the inner casing, the surface facing the outer casing, and
a gap between the outer casing and the inner casing except for where the vacuum insulation panel is provided is filled with a foam insulating material.

The method for producing a vacuum insulation panel of the present invention includes:
(A) preparing a first film laminate having a first heat-sealing layer on the joining side and a second film laminate having a second heat-sealing layer on the joining side, the density of the second heat-sealing layer being higher than the density of the first heat-sealing layer,
(B) arranging the first film laminate and the second film laminate so that the joining side of the first film laminate and the joining side of the second film laminate are in contact with each other to prepare a multilayered assembly, and
(C) subjecting at least part of a peripheral portion of the multilayered assembly to thermocompression so as to heat seal the first heat-sealing layer and the second heat-sealing layer together.

### Advantageous Effects of Invention

The vacuum insulation panel, the heat-insulating box including the vacuum insulation panel, and the method for producing a vacuum insulation panel according to the present invention can achieve improvement of a vacuum insulation panel in terms of the sealing properties to resist foreign matter and the pinhole resistance. In addition, by regulating the amount of gas or water vapor entering the vacuum insulation panel, the insulating effect can be maintained high for an extended period of time.

### BRIEF DESCRIPTION OF DRAWINGS

FIG. 1 is a schematic sectional view of the configuration of a vacuum insulation panel according to Embodiment 1 of the present invention.

FIG. 2 is an enlarged sectional view of a sealed portion of the vacuum insulation panel shown in FIG. 1.

FIG. 3 shows the results of testing effects of a vacuum insulation panel when the density of its heat-sealing layer is changed.

FIG. 4 is a schematic sectional view of the configuration of a vacuum insulation panel according to Embodiment 2 of the present invention.

FIG. 5 is an enlarged sectional view of a sealed portion of the vacuum insulation panel shown in FIG. 4.

FIG. 6 shows the results of testing effects of a vacuum insulation panel when the density of its heat-sealing layer is changed. FIG. 7 is a schematic front view of the configuration of a vacuum insulation panel according to Embodiment 3 of the present invention.

FIG. 8 is a sectional view taken from line A-A of FIG. 7.

FIG. 9 is an enlarged sectional view of a sealed portion of the vacuum insulation panel shown in FIG. 7.

FIG. 10 is a schematic sectional view of the configuration of a first thermocompression jig for use to produce the vacuum insulation panel according to Embodiment 3 of the present invention.

FIG. 11 is a schematic perspective view of the configuration of a heat-insulating box according to Embodiment 4 of the present invention.

FIG. 12 is a sectional view taken from line B-B of FIG. 11.

FIG. 13 is a sectional view taken from line C-C of FIG. 11.

FIG. 14 is a sectional view of a vacuum heat-insulating panel disclosed in PTL 2.

FIG. 15 is a sectional view of a sealing jig used to produce the vacuum heat-insulating panel shown in FIG. 14.

### DESCRIPTION OF EMBODIMENTS

The following describes embodiments of the present invention with reference to drawings. In each drawing, the same or equivalent parts are provided with the same reference numeral, and an overlapping description is omitted. Each drawing includes only the components that are essential for describing the present invention and may not include the other components. The present invention is not limited to the following embodiments.

### Embodiment 1

A vacuum insulation panel according to Embodiment 1 includes: a core material containing an inorganic fiber, a first film laminate having a first heat-sealing layer on the joining side, and a second film laminate having a second heat-sealing layer on the joining side, the density of the first heat-sealing layer being lower than the density of the second heat-sealing layer.

By this configuration in which the heat-sealing layers of the film laminates (outer skin materials) facing each other have different density, the first heat-sealing layer having lower density can give, to the vacuum insulation panel, sealing properties to resist foreign matter and pinhole resistance to prevent glass from making pinholes, while the second heat-sealing layer having higher density can provide the panel with the effect, for example, of regulating the amount of gas or water vapor entering the vacuum insulation panel.

A method for producing the vacuum insulation panel according to Embodiment 1 includes:(A) preparing the first film laminate having the first heat-sealing layer on the joining side and the second film laminate having the second heat-sealing layer on the joining side, the density of the second heat-sealing layer being higher than the density of the first heat-sealing layer, (B) arranging the first film laminate and the second film laminate so that the joining side of the first film laminate and the joining side of the second film laminate are in contact with each other to prepare a multilayered assembly, and (C) subjecting at least part of a peripheral portion of the multilayered assembly to thermocompression so as to heat seal the first heat-sealing layer and the second heat-sealing layer together.

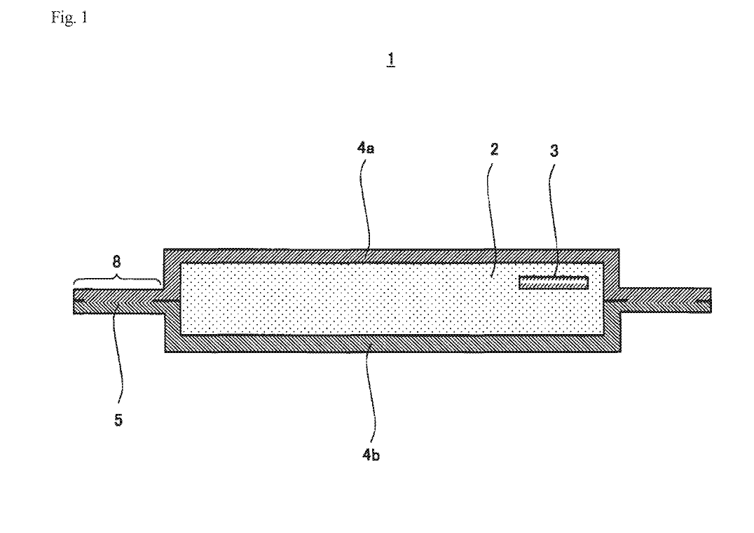

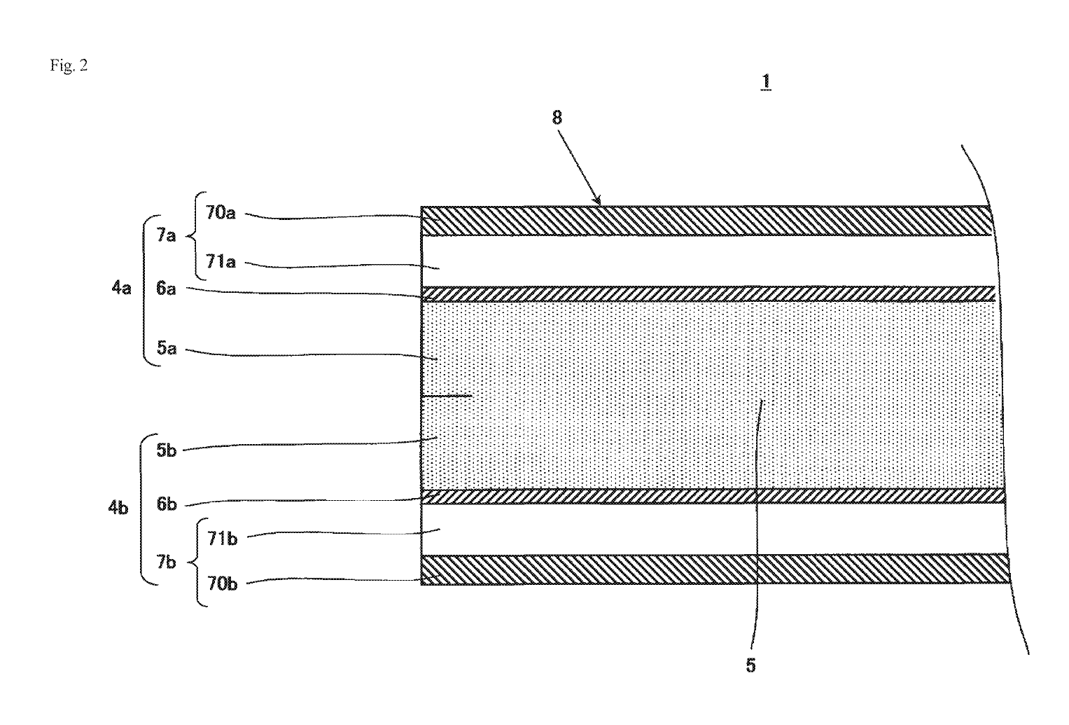

The following describes an example of the vacuum insulation panel according to Embodiment 1, with reference to FIG. 1 and FIG. 2.

Configuration of Vacuum Insulation Panel

FIG. 1 is a schematic sectional view of the configuration of a vacuum insulation panel according to Embodiment 1 of the present invention. FIG. 2 is an enlarged sectional view of a sealed portion of the vacuum insulation panel shown in FIG. 1.

As shown in FIG. 1, a vacuum insulation panel 1 according to Embodiment 1 is rectangular and includes a core material 2 containing a fiber, an adsorbent 3, a first film laminate 4a, and a second film laminate 4b. The core material 2 and the adsorbent 3 are hermetically enclosed within a bag formed with the first film laminate 4a and the second film laminate 4b, under reduced pressure.

The vacuum insulation panel 1 includes a sealed portion 8 formed by heat sealing a peripheral portion of the first film laminate 4a and a peripheral portion of the second film laminate 4b together. A part of the sealed portion 8 where a first heat-sealing layer 5a, to be described below, of the first film laminate 4a and a second heat-sealing layer 5b, to be described below, of the second film laminate 4b form a single layer through heat sealing is sometimes called a heat-sealing layer 5.

The core material 2 serves as an aggregate to form minute gaps within the vacuum insulation panel 1 and, after a vacuum is drawn, forms an insulation portion of the vacuum insulation panel 1. As the core material 2 in Embodiment 1, a glass fiber (a glass wool, for example) is used.

The core material 2, however, is not limited to a glass fiber that is used in Embodiment 1. Instead, a known material including an inorganic fiber such as rock wool, an alumina fiber, and a metal fiber and a polyethylene terephthalate fiber may be used, for example. A metal fiber, when used, may be formed of a metal having relatively low thermal conductivity among metals.

A glass wool is desirably used because its fiber has high elasticity and low thermal conductivity and its industrial production is inexpensive. The thermal conductivity of the vacuum insulation panel tends to decrease as the diameter of the fiber decreases, and therefore the fiber having the smallest diameter possible is desirable. However, such a fiber is not generally used and therefore can be costly. Because of this, it is more desirable to use a glass wool that is an assembly of relatively inexpensive fibers having an average diameter of about 3 μm to about 6 μm generally used as a fiber in a vacuum insulation panel.

The adsorbent 3 serves to adsorb and remove a residual gas component released by vacuum packaging from the minute gaps in the core material 2 into the mass of the vacuum insulation panel 1 and adsorb and remove moisture or gas entering the vacuum insulation panel 1. Examples of the adsorbent 3 include a moisture adsorbent for adsorbing and removing moisture and a gas adsorbent for adsorbing gases such as the atmospheric gas.

As the moisture adsorbent, a chemical adsorbing substance such as calcium oxide and magnesium oxide or a physical adsorbing substance such as zeolite can be used, for example. The gas adsorbent is composed of an adsorbing material capable of adsorbing a non-condensing gas component contained in gas and a container.

Examples of the adsorbing material include alloys of zirconium, vanadium, and tungsten, alloys of iron, manganese, yttrium, lanthanum, and a single rare earth element, Ba-Li alloys, and zeolite having a metal ion through ion exchange. With its ability to adsorb nitrogen, which accounts for about 75% of the air, at normal temperature, each of these adsorbing materials can achieve a high degree of vacuum in the interior of the vacuum insulation panel 1 when used as the adsorbent 3.

Examples of the material to form the container include metal materials such as aluminum, iron, copper, and stainless steel and, in view of cost and ease of handling, aluminum is particularly desirable.

As shown in FIG. 2, the first film laminate 4a includes the first heat-sealing layer 5a, a gas barrier layer 6a, and a surface protective layer 7a in this order from the joining side toward the non-joining side, while the second film laminate 4b includes the second heat-sealing layer 5b, a gas barrier layer 6b, and a surface protective layer 7b in this order from the joining side toward the non-joining side. The first film laminate 4a and the second film laminate 4b serve to inhibit the atmospheric gas from entering the vacuum insulation panel 1 from outside and therefore maintain the degree of vacuum in the interior of the vacuum insulation panel 1.

The first heat-sealing layer 5a and the second heat-sealing layer 5b serve to melt and seal the first film laminate 4a and the second film laminate 4b together to maintain the degree of vacuum in the interior of the vacuum insulation panel 1. The first heat-sealing layer 5a and the second heat-sealing layer 5b also serve to protect the gas barrier layers 6a and 6b from being pierced or the like by the core material 2 or the adsorbent 3 from the interior of the vacuum insulation panel 1.

The first heat-sealing layer 5a and the second heat-sealing layer 5b are formed of a heat-sealing film that is made of a thermoplastic resin. The density of the first heat-sealing layer 5a is lower than the density of the second heat-sealing layer 5b.

The material of the heat-sealing film is not particularly limited, and can be a thermoplastic resin such as low-density polyethylene, linear low-density polyethylene, medium-density polyethylene, high-density polyethylene, polypropylene, and polyacrylonitrile, or a mixture thereof. Among these, polyethylene is desirably selected because it is inexpensive and easily laminated. The first heat-sealing layer 5a and the second heat-sealing layer 5b may be formed of the same material or may be formed of different materials.

From the viewpoints of increasing heat-sealing strength and flexibility and improving sealing properties to resist foreign matter and pinhole resistance, the density of the first heat-sealing layer 5a may be 0.910 to 0.925 g/cm³. From the viewpoints of reducing the amount of gas or water vapor permeating into the vacuum insulation panel 1, the density of the second heat-sealing layer 5b may be 0.935 to 0.950 g/cm³.

Each of the gas barrier layer 6a and the gas barrier layer 6b is a layer formed of one, two, or more kinds of films having excellent barrier properties and gives excellent gas barrier properties to the first film laminate 4a and the second film laminate 4b.

As the gas barrier layer 6a and the gas barrier layer 6b, metal foil such as aluminum foil and copper foil, a film prepared by depositing an atom of a metal such as aluminum and copper or a metal oxide such as alumina and silica to a polyethylene terephthalate film or to an ethylene-vinyl alcohol copolymer via evaporation, or a film prepared by coating a surface to which a metal atom or a metal oxide has been deposited by evaporation can be used, for example. In Embodiment 1, the gas barrier layer 6a and the gas barrier layer 6b are formed of metal foil.

The surface protective layer 7a and the surface protective layer 7b serve to prevent the first film laminate 4a and the second film laminate 4b, in particular the gas barrier layers 6a and 6b, respectively, from having scratches or breaks caused by external force.

As the surface protective layer 7a and the surface protective layer 7b, a known material such as a nylon film, a polyethylene terephthalate film, and a polypropylene film can be used. One kind of the films may be overlaid, or two or more kinds of the films may be overlaid. In Embodiment 1, the surface protective layer 7a is composed of two films 70a and 71a overlaid, while the surface protective layer 7b is composed of two films 70b and 71b overlaid.

### Method for Producing Vacuum Insulation Panel

The following describes an example of the method for producing the vacuum insulation panel 1 according to Embodiment 1.

The first film laminate 4a in a rectangular shape and the second film laminate 4b in a rectangular shape are prepared. Then, the first film laminate 4a and the second film laminate 4b are arranged so that the first heat-sealing layer 5a of the first film laminate 4a and the second heat-sealing layer 5b of the second film laminate 4b face each other, thereby preparing the multilayered assembly.

Heat and pressure are then applied to three sides of the peripheral portions of the first film laminate 4a and the second film laminate 4b so as to heat seal the first heat-sealing layer 5a and the second heat-sealing layer 5b together, thereby preparing a bag-shaped film laminate.

Into the bag-shaped film laminate through its opening are inserted the core material 2 and the adsorbent 3. While a vacuum is being drawn in the bag-shaped film laminate with a vacuum packaging device, the first heat-sealing layer 5a and the second heat-sealing layer 5b are heat sealed together at the opening to give the vacuum insulation panel 1.

### Evaluation Test of Vacuum Insulation Panel

The following shows the results of a test for evaluating effects of the vacuum insulation panel 1 according to Embodiment 1 when the density of its heat-sealing layer was changed.

Evaluation was conducted relative to the results of Comparative Example 1 that used a linear low-density polyethylene film (density: 0.923 g/cm³) generally used as a heat-sealing layer in a vacuum insulation panel. When occurrence of pinholes was higher than in Comparative Example 1 by not more than 20% and thermal conductivity after allowing the panels to stand in a thermostat at 60° C. for 1 month was lower than in Comparative Example 1, the sample was evaluated as superior to Comparative Example 1.

### EXAMPLE 1

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film (density: 0.923 g/cm³) of 50-μm thick was used as a first heat-sealing layer 5a. The layers were bonded together with a urethane-based adhesive to prepare a first film laminate 4a.

A nylon film 70b of 15-μm thick and a nylon film 71b of 25-μm thick were used as a surface protective layer 7b, a piece of aluminum foil of 6-μm thick was used as a gas barrier layer 6b, and a linear low-density polyethylene film (density: 0.935 g/cm³) of 50-μm thick was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 82.4 N.

Into the bag formed of the first film laminate 4a and the second film laminate 4b that were prepared above was enclosed 50 mg of glass shot (a lump of unfiberized glass). After vacuum packaging, a pinhole detector (a pinhole detector TRC-220A (manufactured by Sanko Electronic Laboratory Co., Ltd.), the same apparatus was used in examples and comparative examples below) was used to count pinholes. The number of pinholes was 2.1 per 1 m², indicating that the resulting pinhole resistance was comparable to the pinhole resistance in Comparative Example 1.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the first heat-sealing layer 5a and the second heat-sealing layer 5b at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer (a thermal conductivity measuring device HC-074 300 (manufactured by EKO Instruments), the same apparatus was used in examples and comparative examples below), giving an average value of 0.0020 W/mK. The thermal conductivity of the vacuum insulation panels 1 was measured again after allowing the panels to stand in a thermostat at 60° C. for 1 month, giving an average value of 0.0039 W/mK.

### EXAMPLE 2

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film (density: 0.923 g/cm³) of 50-μm thick was used as a first heat-sealing layer 5a. The layers were bonded together with a urethane-based adhesive to prepare a first film laminate 4a.

A nylon film 70b of 15-μm thick and a nylon film 71b of 25-μm thick were used as a surface protective layer 7b, a piece of aluminum foil of 6-μm thick was used as a gas barrier layer 6b, and a medium-density polyethylene film (density: 0.945 g/cm³) of 50-μm thick was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 62.4 N. This heat-sealing strength was higher by 48.6% than the heat-sealing strength in Comparative Example 3 where the heat-sealing layers contained medium-density polyethylene alone. This phenomenon was attributable to the molecular structure of polyethylene.

Polyethylene has side chains that are branched from an ethylene chain as the main chain.

Thus, the phenomenon above is considered to be explained as follows; the polyethylene having lower density has more side chains than the polyethylene having higher density and therefore, when the polyethylene having lower density and the polyethylene having higher density were heat sealed together, side chains of the polyethylene having lower density were readily bonded to the main chain of the polyethylene having higher density to increase the heat-sealing strength.

Into the bag formed of the first film laminate 4a and the second film laminate 4b that were prepared above was enclosed 50 mg of glass shot. After vacuum packaging, a pinhole detector was used to count pinholes. The number of pinholes was 2.2 per 1 m², which was greater than in Comparative Example 1 by as little as 4.7%.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the first heat-sealing layer 5a and the second heat-sealing layer 5b at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0022 W/mK.

The thermal conductivity of the vacuum insulation panels 1 was measured again after allowing the panels to stand in a thermostat at 60° C. for 1 month, giving an average value of 0.0035 W/mK. This confirmed that deterioration caused by the heat resistance test was smaller than in Comparative Example 1.

### EXAMPLE 3

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film (density: 0.923 g/cm³) of 50-μm thick was used as a first heat-sealing layer 5a. The layers were bonded together with a urethane-based adhesive to prepare a first film laminate 4a.

A nylon film 70b of 15-μm thick and a nylon film 71b of 25-μm thick were used as a surface protective layer 7b, a piece of aluminum foil of 6-μm thick was used as a gas barrier layer 6b, and a high-density polyethylene film (density: 0.950 g/cm³) of 50-μm thick was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 57.8 N. This heat-sealing strength was higher by 68.5% than the heat-sealing strength in Comparative Example 3 where the heat-sealing layers contained high-density polyethylene alone. This phenomenon was attributable to the molecular structure of polyethylene, as in Example 2.

Polyethylene has side chains that are branched from an ethylene chain as the main chain. Thus, the phenomenon above is considered to be explained as follows; the polyethylene having lower density has more side chains than the polyethylene having higher density and therefore, when the polyethylene having lower density and the polyethylene having higher density were heat sealed together, side chains of the polyethylene having lower density were readily bonded to the main chain of the polyethylene having higher density to increase the heat-sealing strength.

Into the bag formed of the first film laminate 4a and the second film laminate 4b that were prepared above was enclosed 50 mg of glass shot. After vacuum packaging, a pinhole detector was used to count pinholes. The number of pinholes was 2.4 per 1 m², which was greater by as little as 14,3%.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0023 W/mK.

The thermal conductivity of the vacuum insulation panels 1 was measured again after allowing the panels to stand in a thermostat at 60° C. for 1 month, giving an average value of 0.0033 W/mK. This confirmed that deterioration caused by the heat resistance test was smaller than in Comparative Example 1.

### Comparative Example 1

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film (density: 0.923 g/cm³) of 50-μm thick was used as a first heat-sealing layer 5a. The layers were bonded together with a urethane-based adhesive to prepare a first film laminate 4a.

For a second film laminate 4b, the same configuration as that of the first film laminate 4a was used. The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 84.5 N.

Into the bag formed of the first film laminate 4a and the second film laminate 4b that were prepared as above was enclosed 50 mg of glass shot. After vacuum packaging, a pinhole detector was used to count pinholes. The number of pinholes was 2.1 per 1 m².

From each of the first film laminate 4a and the second film laminate 4b that were prepared as above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0021 W/mK.

The thermal conductivity of the vacuum insulation panels was measured again after allowing the panels to stand in a thermostat at 60° C. for 1 month, giving an average value of 0.0042 W/mK.

### Comparative Example 2

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film (density: 0.935 g/cm³) of 50-μm thick was used as a first heat-sealing layer 5a. The layers were bonded together with a urethane-based adhesive to prepare a first film laminate 4a.

For a second film laminate 4b, the same configuration as that of the first film laminate 4a was used. The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 73.9 N.

Into the bag formed of the first film laminate 4a and the second film laminate 4b that were prepared above was enclosed 50 mg of glass shot. After vacuum packaging, a pinhole detector was used to count pinholes. The number of pinholes was 3.2 per 1 m², which was significantly higher by 52.4%.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0018 W/mK.

The thermal conductivity of the vacuum insulation panels 1 was measured again after allowing the panels to stand in a thermostat at 60° C. for 1 month, giving an average value of 0.0037 W/mK. This confirmed that deterioration caused by the heat resistance test was greater than in Comparative Example 1.

### Comparative Example 3

A nylon film 70a of 15-μm thick and a nylon film 71a of 25-μm thick were used as a surface protective layer 7a, a piece of aluminum foil of 6-μm thick was used as a gas barrier layer 6a, and a medium-density polyethylene film (density: 0.945 g/cm³) of 50-μm thick was used as a first heat-sealing layer 5a. The layers were bonded together with a urethane-based adhesive to prepare a first film laminate 4a.

For a second film laminate 4b, the same configuration as that of the first film laminate 4a was used. The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 42.0 N.

Into the bag formed of the first film laminate 4a and the second film laminate 4b that were prepared as above was enclosed 50 mg of glass shot. After vacuum packaging, a pinhole detector was used to count pinholes. The number of pinholes was 4.9 per 1 m², which was significantly higher by 133.3%.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0024 W/mK. However, one of the vacuum insulation panels 1 was found to have lost a vacuum because the sealing properties to resist foreign matter were poor so that the air enters through the portion where glass fibers were heat sealed together.

The thermal conductivity of this vacuum insulation panel 1 measured with a thermal conductivity analyzer was 0.0322 W/mK. Because of the potential inability of this vacuum insulation panel 1 to maintain its insulating effect for an extended period of time, a heat resistance test of allowing the panels to stand in a thermostat at 60° C. for 1 month was cancelled.

### Comparative Example 4

A nylon film 70a of 15-μm thick and a nylon film 71a of 25-μm thick were used as a surface protective layer 7a, a piece of aluminum foil of 6-μm thick was used as a gas barrier layer 6a, and a high-density polyethylene film (density: 0.950 g/cm³) of 50-μm thick was used as a first heat-sealing layer 5a. The layers were bonded together with a urethane-based adhesive to prepare a first film laminate 4a.

For a second film laminate 4b, the same configuration as that of the first film laminate 4a was used. The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 34.3 N.

Into the bag formed of the first film laminate 4a and the second film laminate 4b that were prepared above was enclosed 50 mg of glass shot. After vacuum packaging, a pinhole detector was used to count pinholes. The number of pinholes was 6.4 per 1 m², which was significantly higher by 204.8%.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0022 W/mK. However, one of the vacuum insulation panels 1 was found to have lost a vacuum because the sealing properties to resist foreign matter were poor so that the air enters through the portion where glass fibers were heat sealed together.

The thermal conductivity of this vacuum insulation panel 1 measured with a thermal conductivity analyzer was 0.0328 W/mK. Because of the potential inability of this vacuum insulation panel 1 to maintain its insulating effect for an extended period of time, a heat resistance test of allowing the panels to stand in a thermostat at 60° C. for 1 month was cancelled.

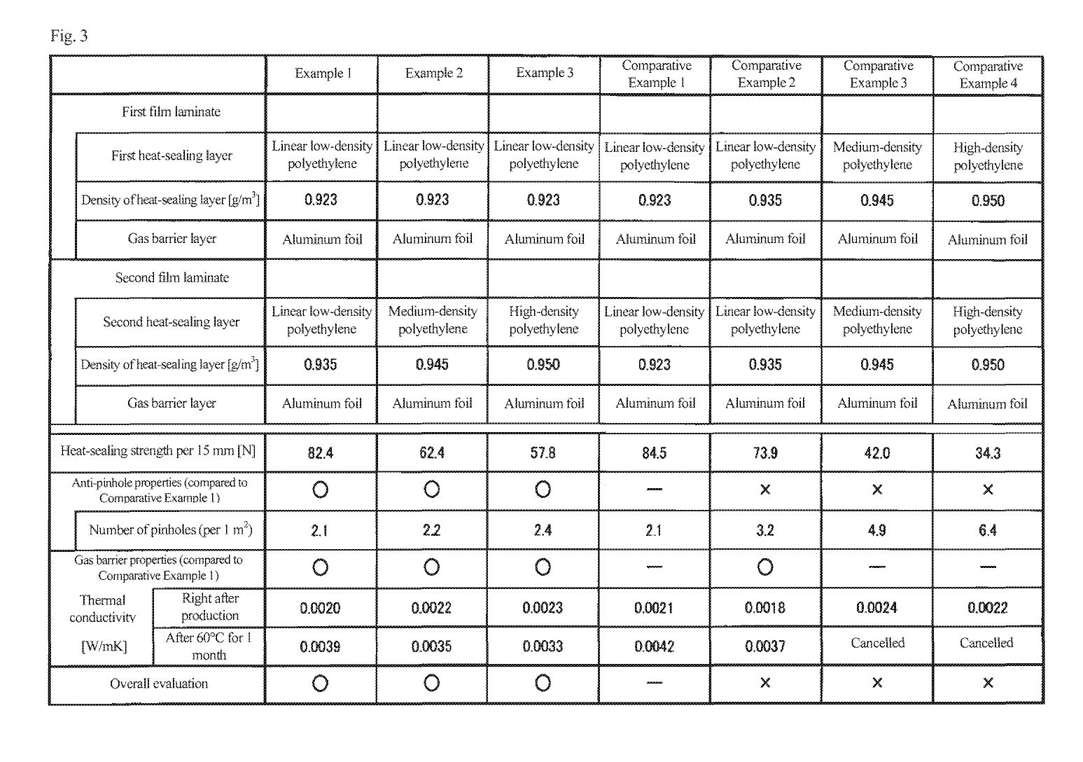

The results of testing effects of the vacuum insulation panels of Examples 1 to 3 and Comparative Examples 1 to 4 thus prepared when the density of the heat-sealing layer was changed are shown in FIG. 3.

FIG. 3 shows the results of testing effects of a vacuum insulation panel when the density of its heat-sealing layer was changed.

As shown in FIG. 3, it was confirmed that, when the density of the first heat-sealing layer 5a is lower than the density of the second heat-sealing layer 5b, the sealing properties to resist foreign matter and the gas barrier properties can be improved simultaneously. In Examples 1 to 3, linear low-density polyethylene was used as the first heat-sealing layer 5a. When low-density polyethylene is used instead, the same effects can still be obtained.

### Embodiment 2

In a vacuum insulation panel according to Embodiment 2, unlike the case of the vacuum insulation panel according to Embodiment 1, a first film laminate has metal foil and a second film laminate has a deposited film. Except for these characteristics, the vacuum insulation panel according to Embodiment 2 may have the same configuration as the configuration of the vacuum insulation panel according to Embodiment 1.

Compared to a film laminate having metal foil, a film laminate having a deposited film is excellent in pinhole resistance to prevent a foreign body from making pinholes. Therefore, even though the film laminate having a deposited film has a second heat-sealing layer having relatively high density formed thereto, degradation in the pinhole resistance can be kept to a minimum. In addition, the metal foil prevents gas or water vapor from entering in the stacking direction of the film laminate, and therefore the insulating effect of the vacuum insulation panel can be maintained high for an extended period of time.

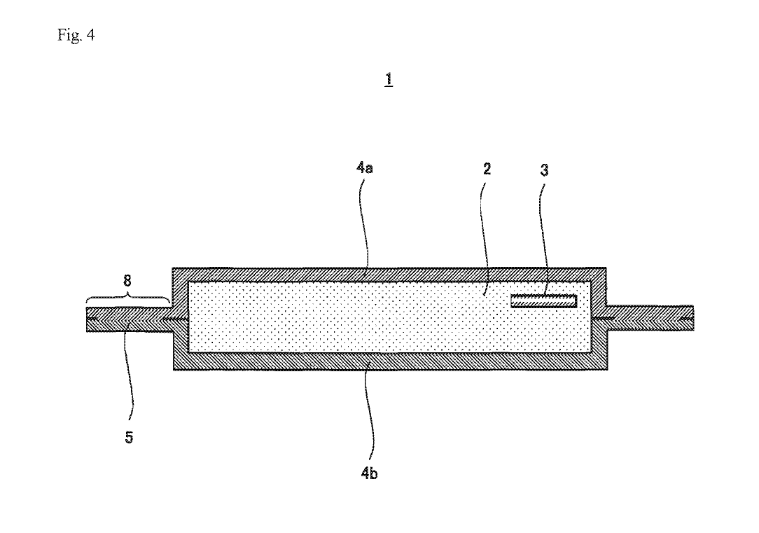

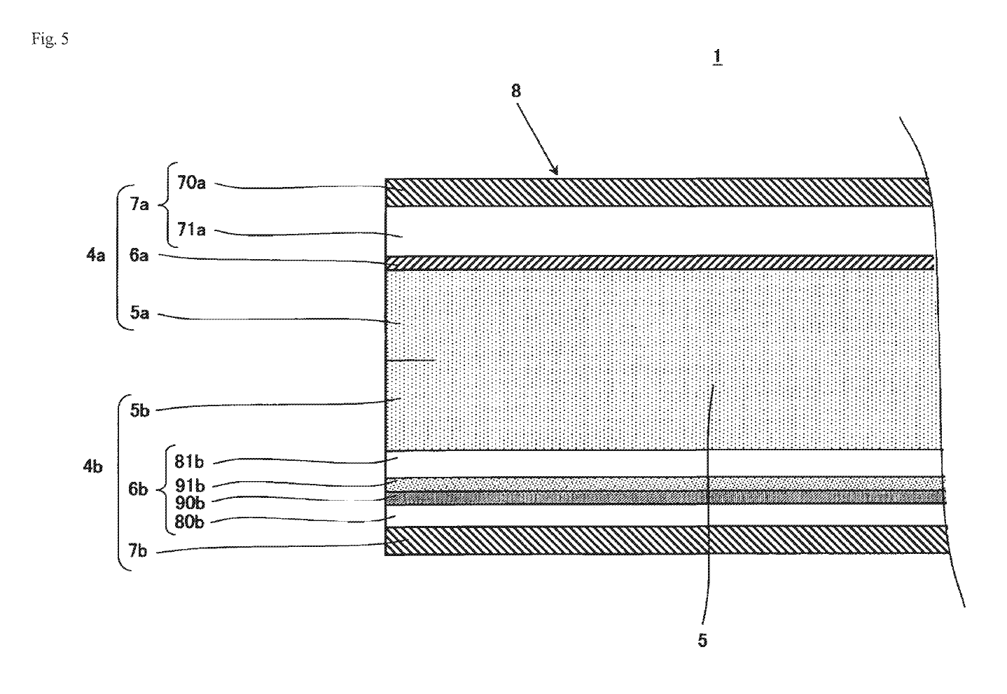

The following describes an example of the vacuum insulation panel according to Embodiment 2, with reference to FIG. 4 and FIG. 5.

### Configuration of Vacuum Insulation Panel

FIG. 4 is a schematic sectional view of the configuration of a vacuum insulation panel according to Embodiment 2. FIG. 5 is an enlarged sectional view of a sealed portion of the vacuum insulation panel shown in FIG. 4.

As shown in FIG. 4 and FIG. 5, a vacuum insulation panel 1 according to Embodiment 2 has the same fundamental configuration as that of the vacuum insulation panel 1 according to Embodiment 1 except for the configuration of a gas barrier layer 6b of a second film laminate 4b.

Specifically, the gas barrier layer 6b has a deposited film 90b that is formed by evaporation of a metal atom onto a base material 80b and a deposited film 91b that is formed by evaporation of a metal atom onto a base material 81b. In Embodiment 2, the deposited film 90b and the deposited film 91b are arranged to be in contact with each other.

Examples of the base material 80b and the base material 81b include a polyethylene terephthalate film and an ethylene-vinyl alcohol copolymer.

However, the configuration is not limited to the one in Embodiment 2 where the deposited film 90b and the deposited film 91b are arranged to be in contact with each other, and may be one where the base material 80b and the base material 81b are arranged to be in contact with each other.

Evaluation Test of Vacuum Insulation Panel

The following shows the results of a test for evaluating effects of the vacuum insulation panel 1 according to Embodiment 2 when the density of its heat-sealing layer was changed.

Evaluation was conducted relative to the results of Comparative Example 1 where metal foil was stacked to a linear low-density polyethylene film (density: 0.923 g/cm³) generally used as a heat-sealing layer in a vacuum insulation panel. When occurrence of pinholes was higher than in Comparative Example 1 by not more than 20%, the sample was evaluated as superior to Comparative Example 1.

As for gas barrier properties, evaluation was conducted relative to the results of Comparative Example 5 where a deposited film was stacked to a linear low-density polyethylene film (density: 0.923 g/cm³) generally used as a heat-sealing layer in a vacuum insulation panel. When thermal conductivity after allowing the panels to stand in a thermostat at 60° C. for 1 month was lower than in Comparative Example 5, the sample was evaluated as superior to Comparative Example 5.

### EXAMPLE 4

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film of 50-μm thick (density: 0.923 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A linear low-density polyethylene film of 50-μm thick (density: 0.935 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 86.1 N.

Into the bag formed of the first film laminate 4a and the second film laminate 4b that were prepared above was enclosed 50 mg of glass shot. After vacuum packaging, a pinhole detector was used to count pinholes. The number of pinholes was 1.7 per 1 m², indicating that the resulting pinhole resistance was greater than the pinhole resistance in Comparative Example 1.

This occurred probably because weak lamination between the deposited film 90b and the deposited film 91b in the gas barrier layer 6b allowed the deposited film 90b and the deposited film 91b to easily come off from each other and therefore impact of shot hitting the film laminate was reduced by the action of the deposited film 90b and the deposited film 91b coming off from each other.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0022 W/mK.

The thermal conductivity of the vacuum insulation panels 1 was measured again after allowing the panels to stand in a thermostat at 60° C. for 1 month, giving an average value of 0.0044 W/mK.

### EXAMPLE 5

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film of 50-μm thick (density: 0.923 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A medium-density polyethylene film of 50-μm thick (density: 0.945 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 63.3 N.

Into the bag formed of the first film laminate 4a and the second film laminate 4b that were prepared above was enclosed 50 mg of glass shot. After vacuum packaging, a pinhole detector was used to count pinholes. The number of pinholes was 1.9 per 1 m², indicating that the resulting pinhole resistance was greater than the pinhole resistance in Comparative Example 1.

This occurred probably because weak lamination between the deposited film 90b and the deposited film 91b in the gas barrier layer 6b allowed the deposited film 90b and the deposited film 91b to easily come off from each other and therefore impact of shot hitting the film laminate was reduced by the action of the deposited film 90b and the deposited film 91b coming off from each other.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0023 W/mK.

The thermal conductivity of the vacuum insulation panels 1 was measured again after allowing the panels to stand in a thermostat at 60° C. for 1 month, giving an average value of 0.0041 W/mK.

### EXAMPLE 6

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film of 50-μm thick (density: 0.923 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A high-density polyethylene film of 50-μm thick (density: 0.950 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 60.7 N.

Into the bag formed of the first film laminate 4a and the second film laminate 4b that were prepared above was enclosed 50 mg of glass shot. After vacuum packaging, a pinhole detector was used to count pinholes. The number of pinholes was 2.0 per 1 m², indicating that the resulting pinhole resistance was greater than the pinhole resistance in Comparative Example 1.

This occurred probably because weak lamination between the deposited film 90b and the deposited film 91b in the gas barrier layer 6b allowed the deposited film 90b and the deposited film 91b to easily come off from each other and therefore impact of shot hitting the film laminate was reduced by the action of the deposited film 90b and the deposited film 91b coming off from each other.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0019 W/mK.

The thermal conductivity of the vacuum insulation panels 1 was measured again after allowing the panels to stand in a thermostat at 60° C. for 1 month, giving an average value of 0.0040 W/mK.

### Comparative Example 5

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film of 50-μm thick (density: 0.923 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A linear low-density polyethylene film of 50-μm thick (density: 0.923 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 88.2 N.

Into the bag formed of the first film laminate 4a and the second film laminate 4b that were prepared above was enclosed 50 mg of glass shot. After vacuum packaging, a pinhole detector was used to count pinholes. The number of pinholes was 1.5 per 1 m².

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels were prepared. The thermal conductivity of the vacuum insulation panels 1 was measured with a thermal conductivity analyzer, giving an average value of 0.0023 W/mK.

The thermal conductivity of the vacuum insulation panels 1 was measured again after allowing the panels to stand in a thermostat at 60° C. for 1 month, giving an average value of 0.0048 W/mK.

### Comparative Example 6

A nylon film 70a of 15-μm thick and a nylon film 71a of 25-μm thick were used as a surface protective layer 7a, a piece of aluminum foil of 6-μm thick was used as a gas barrier layer 6a, and a linear low-density polyethylene film of 50-μm thick (density: 0.935 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A linear low-density polyethylene film of 50-μm thick (density: 0.923 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 85.6 N, which was substantially equivalent to the heat-sealing strength in Example 4.

Into the bag formed of the first film laminate 4a and the second film laminate 4b that were prepared above was enclosed 50 mg of glass shot. After vacuum packaging, a pinhole detector was used to count pinholes. The number of pinholes was, however, 2.3 per 1 m² indicating that the resulting pinhole resistance was lower than the pinhole resistance in Comparative Example 1 and Example 4.

This occurred probably because the first film laminate 4a had the first heat-sealing layer 5a having relatively high density stacked with metal foil and therefore had many pinholes formed therein.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0020 W/mK.

The thermal conductivity of the vacuum insulation panels 1 was measured again after allowing the panels to stand in a thermostat at 60° C. for 1 month, giving an average value of 0.0043 W/mK, which was not greatly different from the value in Example 4.

### Comparative Example 7

A nylon film 70a of 15-μm thick and a nylon film 71a of 25-μm thick were used as a surface protective layer 7a, a piece of aluminum foil of 6-μm thick was used as a gas barrier layer 6a, and a medium-density polyethylene film of 50-μm thick (density: 0.945 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A linear low-density polyethylene film of 50-μm thick (density: 0.923 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 60.5 N, which was substantially equivalent to the heat-sealing strength in Example 5.

Into the bag formed of the first film laminate 4a and the second film laminate 4b that were prepared above was enclosed 50 mg of glass shot. After vacuum packaging, a pinhole detector was used to count pinholes. The number of pinholes was, however, 3.2 per 1 m² indicating that the resulting pinhole resistance was lower than the pinhole resistance in Comparative Example 1 and Example 5.

This occurred probably because the first film laminate 4a had the first heat-sealing layer 5a having relatively high density stacked with metal foil and therefore had many pinholes formed therein.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4 μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels 1 were prepared. The thermal conductivity of the vacuum insulation panels 1 was measured with a thermal conductivity analyzer, giving an average value of 0.0022 W/mK. However, one of the vacuum insulation panels 1 was found to have lost a vacuum because the sealing properties to resist foreign matter were poor enough to allow air to enter through the portion where glass fibers were heat sealed together.

The thermal conductivity of this vacuum insulation panel 1 measured with a thermal conductivity analyzer was 0.0336 W/mK. Because of the potential inability of this vacuum insulation panel 1 to maintain its insulating effect for an extended period of time, a heat resistance test of allowing the panels to stand in a thermostat at 60° C. for 1 month was cancelled.

### Comparative Example 8

A nylon film 70a of 15-μm thick and a nylon film 71a of 25-μm thick were used as a surface protective layer 7a, a piece of aluminum foil of 6-μm thick was used as a gas barrier layer 6a, and a high-density polyethylene film of 50-μm thick (density: 0.950 g/cm³) was used as a first heat-sealing layer 5a. The layers were bonded together with a urethane-based adhesive to prepare a first film laminate 4a.

A nylon film of 25-μm thick was used as a surface protective layer 7b. An aluminum-deposited film (a deposited film 90b) was provided onto a polyethylene terephthalate film of 12-μm thick (a base material 80b) to form a film, while an aluminum-deposited film (a deposited film 91b) was provided onto an ethylene-vinyl alcohol copolymer film of 12-μm thick (a base material 81b) to form a film, and both of the resulting films were stacked so that the aluminum-deposited films faced each other, giving a gas barrier layer 6b. A linear low-density polyethylene film of 50-μm thick (density: 0.923 g/cm³) was used as a second heat-sealing layer 5b. The layers were bonded together with a urethane-based adhesive to prepare a second film laminate 4b.

The resulting first film laminate 4a and the resulting second film laminate 4b were arranged so that the first heat-sealing layer 5a and the second heat-sealing layer 5b faced each other, followed by heat sealing. The heat-sealing strength for a width of 15 mm measured 58.8 N, which was substantially equivalent to the heat-sealing strength in Example 6.

Into the bag formed of the first film laminate 4a and the second film laminate 4b that were prepared above was enclosed 50 mg of glass shot. After vacuum packaging, a pinhole detector was used to count pinholes. The number of pinholes was, however, 3.9 per 1 m² indicating that the resulting pinhole resistance was lower than the pinhole resistance in Comparative Example 1 and Example 6.

This occurred probably because the first film laminate 4a had the first heat-sealing layer 5a having relatively high density stacked with metal foil and therefore had many pinholes formed therein.

From each of the first film laminate 4a and the second film laminate 4b that were prepared above, a fragment of 300-mm wide and 400-mm long was cut out, and these fragments were heat sealed together to prepare a bag that had its opening at the short sides of the fragments. When preparing the bag, several glass fibers having an average fiber diameter of 4μm were heat sealed together with the heat-sealing layers at a portion in the long side.

Into the bag were inserted a core material 2 of 250-mm wide and 320-mm long made of glass fiber and an adsorbent 3, followed by heat sealing of the opening in an atmosphere under reduced pressure. In this way, ten vacuum insulation panels were prepared. The thermal conductivity of the vacuum insulation panels 1 was measured with a thermal conductivity analyzer, giving an average value of 0.0020 W/mK. However, one of the vacuum insulation panels 1 was found to have lost a vacuum because the sealing properties to resist foreign matter were poor enough to allow air to enter through the portion where glass fibers were heat sealed together.

The thermal conductivity of this vacuum insulation panel 1 measured with a thermal conductivity analyzer was 0.0324 W/mK. Because of the potential inability of this vacuum insulation panel 1 to maintain its insulating effect for an extended period of time, a heat resistance test of allowing the panels to stand in a thermostat at 60° C. for 1 month was cancelled.

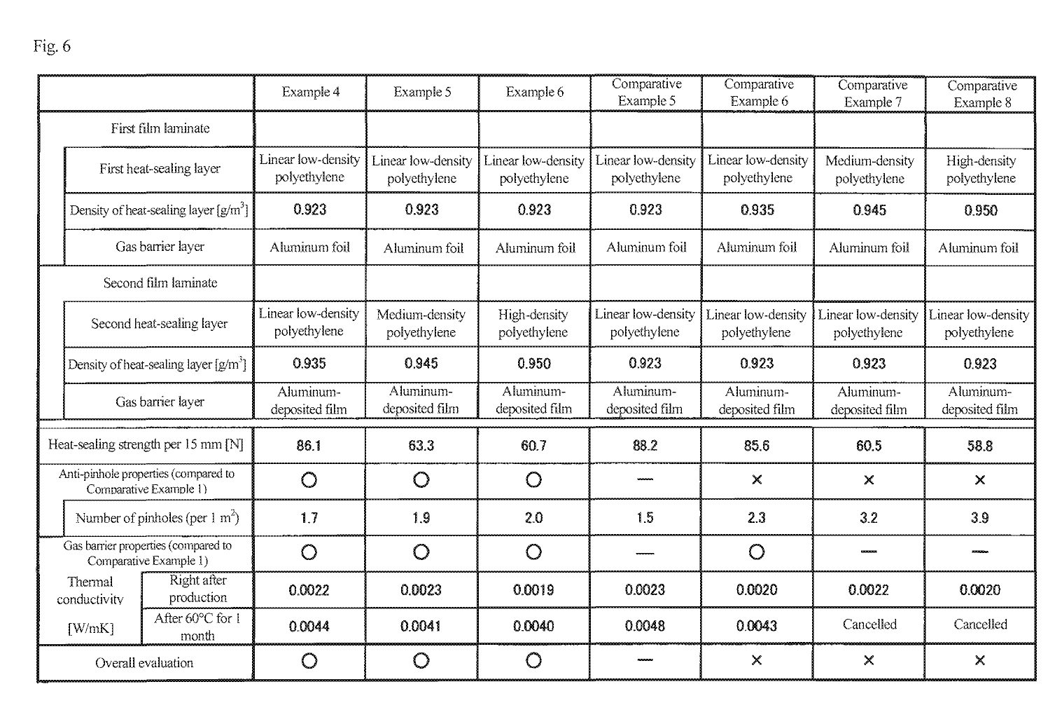

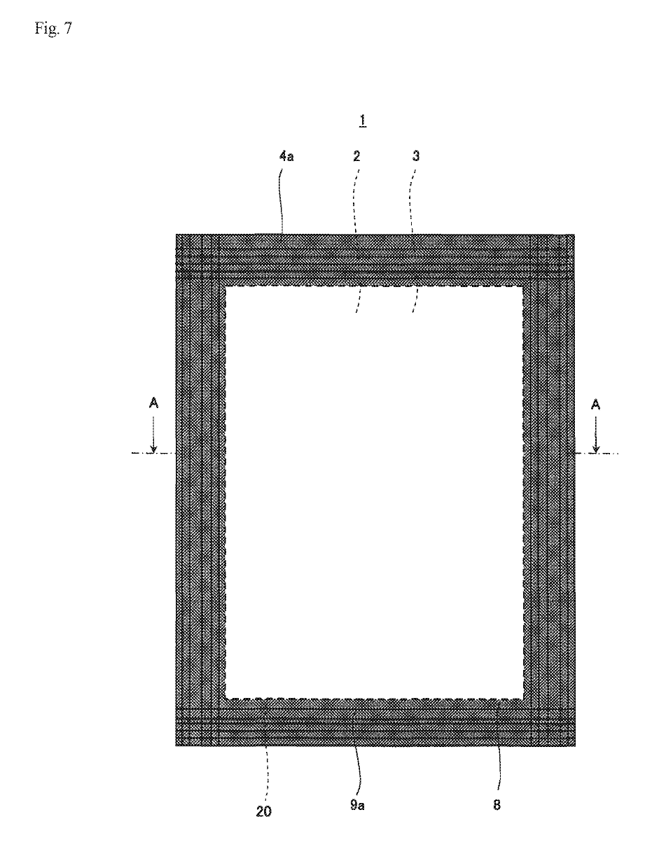

The results of testing effects of the vacuum insulation panels of Examples 4 to 6 and Comparative Examples 5 to 8 thus prepared when the density of the heat-sealing layer was changed are shown in FIG. 6.

FIG. 6 shows the results of testing effects of a vacuum insulation panel when the density of its heat-sealing layer was changed.

As shown in FIG. 6, it was confirmed that, when the density of the heat-sealing layers of the facing film laminates is changed so that a heat-sealing layer having relatively high density is provided to a film laminate having a deposited film, the sealing properties to resist foreign matter and the gas barrier properties can be improved simultaneously.

In Examples 4 to 6 and Examples 1 to 3, linear low-density polyethylene was used as the first heat-sealing layer 5a. When low-density polyethylene is used instead, the same effects can still be obtained. In addition, although the gas barrier layers in Examples 4 to 6 were arranged so that the deposited films faced each other, this is not limitative. The same effects can still be obtained when the gas barrier layers are arranged so that the deposited films do not face each other.

### Embodiment 3

A vacuum insulation panel according to Embodiment 3, unlike the vacuum insulation panel according to Embodiment 1 or 2, further includes: a sealed portion including a heat-sealing layer formed through heat sealing of the joining side of a peripheral portion of a first heat-sealing layer with the joining side of a peripheral portion of a second heat-sealing layer, so that a core material is hermetically enclosed under reduced pressure, in which the sealed portion has a corrugated shape with the ridge height of the non-joining side of the first heat-sealing layer being greater than the ridge height of the non-joining side of the second heat-sealing layer, and the sealed portion includes a first concave portion depressed in the direction from the first film laminate toward the second film laminate and a second concave portion depressed in the direction from the second film laminate toward the first film laminate, a most-depressed portion of the first concave portion includes a thin portion where the heat-sealing layer is thinner than the heat-sealing layer surrounding the most-depressed portion, and the first concave portion and the second concave portion are arranged not to face each other.

In the thin portion of the heat-sealing layer, the area within the end face of the first film laminate or the second film laminate through which gas and moisture can enter is accordingly small and therefore the resistance to permeation of gas and moisture is high. Because of this, in the thin portion, the permeation rate of gas and moisture is low and therefore the amount of gas and moisture permeating over time is low. As a result, the vacuum insulation panel according to Embodiment 3 can maintain excellent hermeticity for an extended period of time.

In addition, in the vacuum insulation panel according to Embodiment 3, the sealed portion has a corrugated shape with the arched first concave portion and the arched second concave portion. Because of this, a sharp edge that is formed in the vacuum heat-insulating panel disclosed in PTL 1 rarely forms.

As a result, when metal foil is used as a gas barrier layer, stress is less likely to be applied locally in the metal foil and therefore incidence of cracks within the metal foil is extremely low.

Furthermore, in the vacuum insulation panel according to Embodiment 3, the sealed portion has a corrugated shape with the arched first concave portion and the arched second concave portion. Therefore, the thickness of the heat-sealing layer increases and decreases continuously and gradually and, then, the strength of the sealed portion also increases and decreases continuously and gradually. Accordingly, stress is less likely to be applied locally in the thin portion of the heat-sealing layer. As a result, incidence of cracks within the thin portion of the heat-sealing layer and within the film laminate near the thin portion is extremely low or incidence of breaks within the sealed portion is extremely low.

The method for producing the vacuum insulation panel according to Embodiment 3 includes: (A) preparing the first film laminate having the first heat-sealing layer on the joining side and the second film laminate having the second heat-sealing layer on the joining side, the density of the second heat-sealing layer being higher than the density of the first heat-sealing layer, (B) arranging the first film laminate and the second film laminate so that the joining side of the first film laminate and the joining side of the second film laminate are in contact with each other, to prepare a multilayered assembly, and (C) subjecting at least part of a peripheral portion of the multilayered assembly to thermocompression so as to heat seal the first heat-sealing layer and the second heat-sealing layer together, in which in the step (C), heat and pressure are applied to the non-joining side of the first film laminate with a first thermocompression jig having a protrusion with an arched tip and heat and pressure are applied to the non-joining side of the second film laminate with a second, platy thermocompression jig, so as to heat seal the first heat-sealing layer and the second heat-sealing layer together and form the sealed portion into a corrugated shape.

In the method for producing the vacuum insulation panel according to Embodiment 3, the step (C) may include: (C1) applying heat and pressure to the non-joining side of the first film laminate and the non-joining side of the second film laminate with a pair of platy thermocompression jigs so as to heat seal the first heat-sealing layer and the second heat-sealing layer together, and (C2) applying heat and pressure to the non joining side of the first film laminate with the first thermocompression jig having a protrusion with an arched tip and applying heat and pressure to the non-joining side of the second film laminate with the second, platy thermocompression jig, so as to form the sealed portion into a corrugated shape.

The following describes an example of the vacuum insulation panel according to Embodiment 3, with reference to FIG. 7 to FIG. 10.

Configuration of Vacuum Insulation Panel

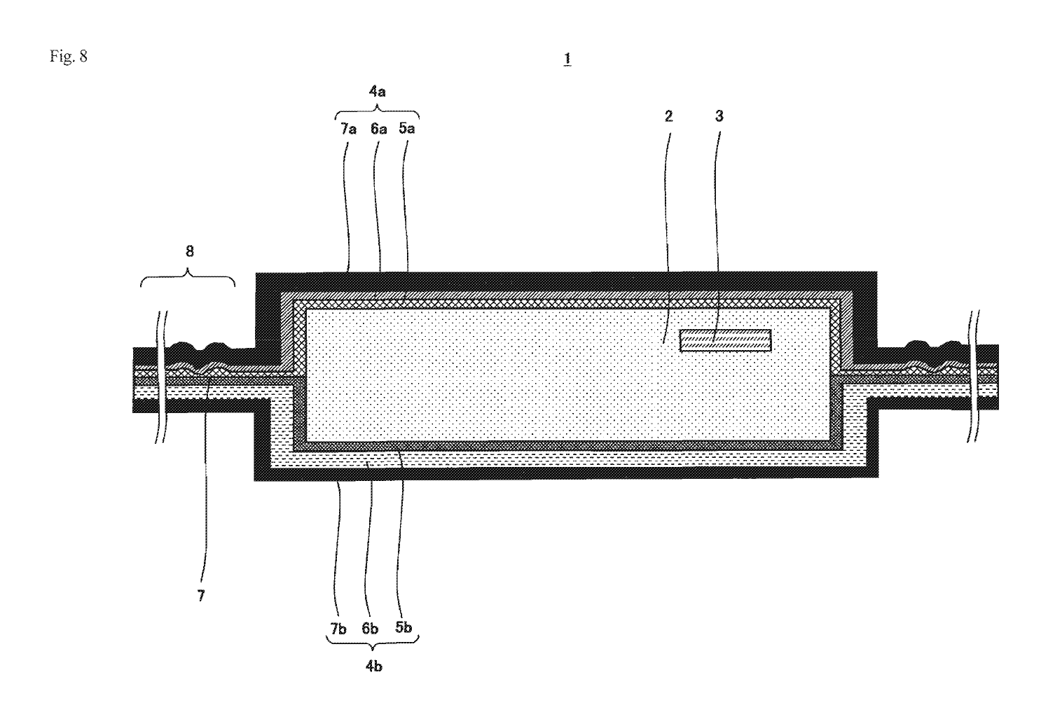

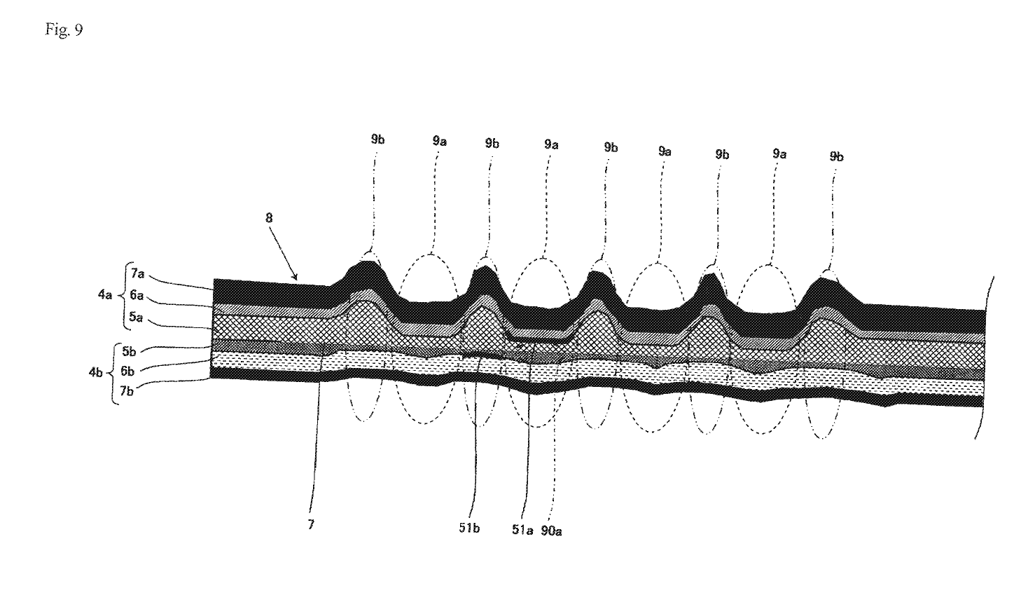

FIG. 7 is a schematic front view of the configuration of a vacuum insulation panel according to Embodiment 3. FIG. 8 is a sectional view taken from line A-A of FIG. 7. FIG. 9 is an enlarged sectional view of a sealed portion of the vacuum insulation panel shown in FIG. 7. In FIG. 7, the sealed portion is shown with hatching. In FIG. 8, part of the vacuum insulation panel (the sealed portion) is not shown. In FIG. 9, part of the non-joining sides of the first heat-sealing layer and the second heat-sealing layer is shown with bold lines.

As shown in FIG. 7 to FIG. 9, a vacuum insulation panel 1 according to Embodiment 3 has the same fundamental configuration as that of the vacuum insulation panel 1 according to Embodiment 1 except that a sealed portion 8 has a corrugated shape. Specifically, in the sealed portion 8, the ridge height of the non-joining side of a first heat-sealing layer 5a of a heat-sealing layer 5 is greater than the ridge height of the non-joining side of a second heat-sealing layer 5b of the heat-sealing layer 5.

In addition, the sealed portion 8 includes a first concave portion 9a depressed in the direction from a first film laminate 4a toward a second film laminate 4b and a second concave portion 9b depressed in the direction from the second film laminate 4b toward the first film laminate 4a.

The first concave portion 9a and the second concave portion 9b are arranged alternately. In other words, the first concave portion 9a and the second concave portion 9b are not arranged perpendicular to each other as viewed from the thickness direction of the vacuum insulation panel 1. Although the first concave portion 9a (the second concave portion 9b) on a side is arranged perpendicular to another in Embodiment 3, this is not limitative. Alternatively, the first concave portion 9a (the second concave portion 9b) may be arranged not to cross another. In addition, although the first concave portion 9a (the second concave portion 9b) is provided on each of the four sides in Embodiment 3, this is not limitative. The first concave portion 9a (the second concave portion 9b) is simply required to be provided on at least one side and may be provided on three sides, for example.

Furthermore, the depth (size) of a non-joining side 51a (a part shown with a bold line in FIG. 9) of the first heat-sealing layer 5a in the first concave portion 9a is greater than the depth (size) of a non-joining side 51b (a part shown with a bold line in FIG. 9) of the second heat-sealing layer 5b in the second concave portion 9b. In other words, the first concave portion 9a and the second concave portion 9b are formed so that the radius of curvature of the non-joining side 51a of the first heat-sealing layer 5a in the first concave portion 9a is smaller than the radius of curvature of the non-joining side 51b of the second heat-sealing layer 5b in the second concave portion 9b.

The distance between the first concave portion 9a and the second concave portion 9b can be optionally selected provided that a gas barrier layer 6a and a gas barrier layer 6b are not impaired. The first concave portion 9a and the second concave portion 9b may be arranged to have a certain distance between them or may be arranged not to have a certain distance between them.

The radius of curvature of the first concave portion 9a and the radius of curvature of the second concave portion 9b can be optionally selected provided that the gas barrier layer 6a and the gas barrier layer 6b are not impaired. Each first concave portion 9a may have the same radius of curvature or may have a different radius of curvature. Similarly, each second concave portion 9b may have the same radius of curvature or may have a different radius of curvature.

The most-depressed portion of the heat-sealing layer 5 in the first concave portion 9a includes a thin portion 90a where the heat-sealing layer 5 is thinner than the heat-sealing layer surrounding the most-depressed portion. From the viewpoint of more effectively inhibiting gas or moisture from entering the vacuum insulation panel 1, the thin portion 90a may be provided at two or more positions per side. In Embodiment 4, the thin portion 90a is provided at four positions per side.

From the viewpoint of thorough heat sealing of the first heat-sealing layer 5a and the second heat-sealing layer 5b, the thin portion 90a may be provided inside the vicinity of the outer circumference of the vacuum insulation panel 1 (the vicinity being 1 to 2 mm away from the outer circumference of the vacuum insulation panel 1, for example), or may be provided outside the vicinity of the inner circumference 20 (see FIG. 2) of the sealed portion 8 (the vicinity being 1 to 2 mm away from the inner circumference 20 of the sealed portion 8, for example). The thickness of the heat-sealing layer 5 may or may not be the same between the thin portions 90a.

The gas barrier layer 6a and the gas barrier layer 6b may be formed of metal foil as in the vacuum insulation panel 1 according to Embodiment 1. Alternatively, as in the vacuum insulation panel 1 according to Embodiment 2, the gas barrier layer 6a may be formed of metal foil and the gas barrier layer 6b may be formed of a deposited film layer.

Method for Producing Vacuum Insulation Panel

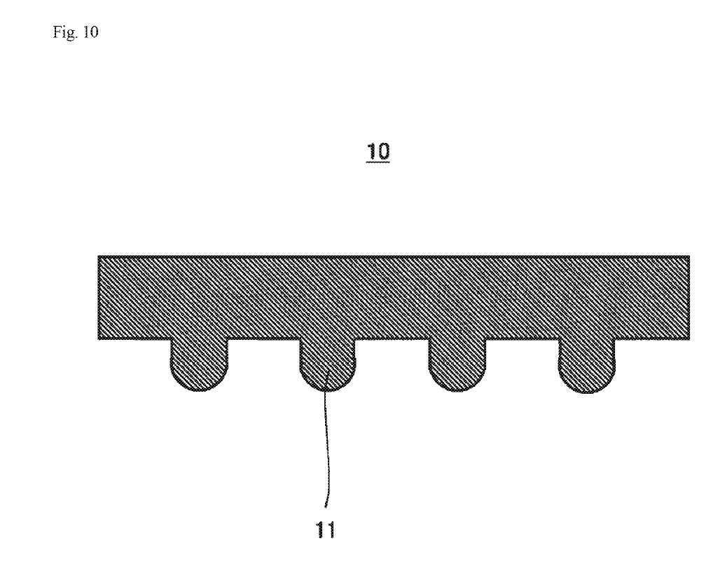

FIG. 10 is a schematic sectional view of the configuration of a first thermocompression jig for use to produce the vacuum insulation panel according to Embodiment 3.

First, the first thermocompression jig for use to produce the vacuum insulation panel according to Embodiment 3 is described with reference to FIG. 10.

As shown in FIG. 10, a first thermocompression jig 10 made of metal includes a plurality of protrusions 11 (four protrusions 11 in the drawing). The protrusions 11 extend in streak, and the tip of each protrusion 11 is arched. The distance between adjacent protrusions 11 can be optionally selected. The radius of curvature of the tip of the protrusion 11 can also be optionally selected.

The following describes an example of the method for producing the vacuum insulation panel 1 according to Embodiment 3, with reference to FIG. 7 to FIG. 10.

The first film laminate 4a in a rectangular shape and the second film laminate 4b in a rectangular shape are prepared. Then, the first film laminate 4a and the second film laminate 4b are arranged so that the first heat-sealing layer 5a of the first film laminate 4a and the second heat-sealing layer 5b of the second film laminate 4b face each other, thereby preparing the multilayered assembly.

Heat and pressure are then applied to three sides of the peripheral portions of the first film laminate 4a and the second film laminate 4b so as to heat seal the first heat-sealing layer 5a and the second heat-sealing layer 5b together, thereby preparing a bag-shaped film laminate.

This thermocompression is achieved by sandwiching the multilayered assembly of the first film laminate 4a and the second film laminate 4b between the first thermocompression jig 10 and a silicon rubber heater 12 (a second thermocompression jig).

Specifically, heat and pressure are applied to the non-joining side of the first film laminate 4a with the first thermocompression jig 10, while heat and pressure are applied to the non-joining side of the second film laminate 4b with the silicon rubber heater 12. As a result, the first heat-sealing layer 5a and the second heat-sealing layer 5b are heat sealed together to form the sealed portion 8 into a corrugated shape.

Into the bag-shaped film laminate through its opening are inserted a core material 2 and an adsorbent 3. While a vacuum is being drawn in the bag-shaped film laminate with a vacuum packaging device, the first heat-sealing layer 5a and the second heat-sealing layer 5b are heat sealed together at the opening to give the vacuum insulation panel 1.

There are two reasons why the first thermocompression jig 10 is used for applying heat and pressure to the non-joining side of the first film laminate 4a and the silicon rubber heater 12 is used for applying heat and pressure to the non-joining side of the second film laminate 4b, as described below.

One of the reasons is that the first heat-sealing layer 5a having lower density flows more easily along the contour of the first thermocompression jig 10 when forming the sealed portion 8 into a corrugated shape. The other reason is that, if the first thermocompression jig 10 is used for applying heat and pressure to the non-joining side of the second film laminate 4b that has the second heat-sealing layer 5b having higher density, tear edge may occur at the edge of the sealed portion 8.

Although the first thermocompression jig 10 and the silicon rubber heater 12 are used here to simultaneously conduct heat sealing of the first film laminate 4a and the second film laminate 4b and formation of the corrugated sealed portion 8, the configuration is not limited to this. Another configuration may be adopted, for example, where a common platy jig is used on the first film laminate 4a and the second film laminate 4b to form the sealed portion 8 in which the heat-sealing layer has no thin portion and has substantially uniform thickness and, then, the first thermocompression jig 10 and the silicon rubber heater 12 are used on the resulting sealed portion 8 to conduct thermocompression so as to form the sealed portion 8 into a corrugated shape.

As described above, when sealing the opening, or the fourth side, of the bag, use of a vacuum packaging device is required so as to hermetically seal the bag while reducing the pressure in the bag.

A common vacuum packaging device is provided with a platy heat-sealing jig. Therefore, when sealing the bag made with the first film laminate 4a and the second film laminate 4b, use of the vacuum packaging device to seal at least the opening of the bag gives the sealed portion 8 having substantially uniform thickness in the heat-sealing layer 5. After forming the sealed portion 8 on the fourth side, the first thermocompression jig 10 and the silicon rubber heater 12 may be used for thermocompression to form the sealed portion 8 into a corrugated shape.

Effects of Vacuum Insulation Panel

The vacuum insulation panel 1 according to Embodiment 3 having such a configuration has the thin portion 90a where the heat-sealing layer 5 of the sealed portion 8 is thinner than the area surrounding the thin portion 90a. Because of this, in the thin portion 90a, the area within the end face of the first film laminate 4a or the second film laminate 4b through which gas and moisture can enter is accordingly small. This increases resistance to permeation of gas and moisture and reduces the permeation rate of gas and moisture, and therefore the amount of gas and moisture permeating over time is reduced. As a result, the vacuum insulation panel 1 can maintain excellent hermeticity for an extended period of time.

In addition, in the vacuum insulation panel 1 according to Embodiment 3, the sealed portion 8 has a corrugated shape with the arched first concave portion 9a and the arched second concave portion 9b. Because of this, the gas barrier layer 6a and the gas barrier layer 6b bend to form an arch and rarely form a sharp edge. As a result, incidence of cracks within the gas barrier layer 6a and the gas barrier layer 6b is extremely low.

In the thin portion 90a of the heat-sealing layer 5, the heat-sealing layer 5 is thinner than the area surrounding the thin portion 90a and accordingly the strength is lower by the loss of thickness. However, in the vacuum insulation panel 1 according to Embodiment 3, the sealed portion 8 has a corrugated shape with the arched first concave portion 9a and the arched second concave portion 9b, and therefore the thickness of the heat-sealing layer 5 increases and decreases continuously and gradually.

Because of this, the strength (flexural strength, for example) of the sealed portion 8 also increases and decreases continuously and gradually across the sealed portion 8. As a result, external force is less likely to be applied locally in the thin portion 90a of the heat-sealing layer 5. Accordingly, incidence of cracks within or near the thin portion 90a of the heat-sealing layer 5 is extremely low, and incidence of breaks within the sealed portion 8 is extremely low.

Thus, in the vacuum insulation panel 1 according to Embodiment 3, incidence of cracks within or near the thin portion 90a of the heat-sealing layer 5 is low, and incidence of breaks within the sealed portion 8 is extremely low. As a result, the vacuum insulation panel 1 according to Embodiment 3 can maintain excellent insulation for an extended period of time.

Within or near the thin portion 90a closer to the non-joining side than the heat-sealing layer 5, the first heat-sealing layer 5a and the gas barrier layer 6b of the first film laminate 4a and the second heat-sealing layer 5b and the gas barrier layer 6b of the second film laminate 4b become distorted along the contour of the heat-sealing layer 5 and accordingly receive stress, potentially leading to a decrease in the strength of the first film laminate 4a and the second film laminate 4b.

In the sealed portion 8 of the vacuum insulation panel 1 according to Embodiment 3, however, the ridge height of the non-joining side of the first heat-sealing layer 5a of the heat-sealing layer 5 is greater than the ridge height of the non-joining side of the second heat-sealing layer 5b of the heat-sealing layer 5.

Because of this, in the sealed portion 8, a decrease in the strength in the second film laminate 4b is smaller than a decrease in the strength in the first film laminate 4a. Therefore, in the sealed portion 8, the second film laminate 4b supports the second film laminate 4b to maintain the rigidity. As a result, when external force is applied to the vacuum insulation panel 1, incidence of cracks within and near the thin portion 90a of the heat-sealing layer 5 and incidence of breaks within the sealed portion 8 are extremely low.

In addition, in the vacuum insulation panel 1 according to Embodiment 3, the first concave portion 9a and the second concave portion 9b are arranged not to face each other as viewed from the thickness direction of the vacuum insulation panel 1. Therefore, compared to the vacuum heat-insulating panel in PTL 1 where concave portions are arranged so as to face each other, a decrease in the strength caused by distortion of the sealed portion 8 can be low. Furthermore, when external force is applied to the sealed portion 8, incidence of scratches in the sealed portion 8 is extremely low, incidence of breaks within the sealed portion 8 is extremely low, and incidence of cracks within the gas barrier layer 6a in the first concave portion 9a or within the gas barrier layer 6b in the second concave portion 9b is further reduced.

The vacuum insulation panel 1 according to Embodiment 3 may further have two or more thin portions 90a per one side of the outer circumference of the vacuum insulation panel 1.

In the thin portion 90a, the heat-sealing layer 5 is thinner and sealing strength is lower than in the other area of the sealed portion 8. Therefore, when heat sealing of the film laminates is conducted during production and a glass fiber, a silica powder, or the like as a constituent of the core material 2 is sandwiched in-between, defective heat sealing may occur in the thin portion 90a.

Where defective heat sealing occurs, no resin is present and therefore effect of inhibiting gas from entering is low. This is prevented by providing at least two or more thin portions 90a so as to reduce the influence of defective heat sealing, namely, so as to reduce acceleration of gas and moisture entering the vacuum insulation panel 1.

Particularly when a glass fiber is used as the core material 2, in which case the core material 2 often becomes sandwiched during heat sealing to act as foreign matter and then becomes deformed due to heat to form a through hole in the thin portion 90a, (this embodiment of) the present invention displays its effects more significantly.

In addition, in the thin portion 90a, the film laminate is less strong than the area surrounding the thin portion 90a. Because of this, when external force is applied to the thin portion 90a, the load may be locally applied to the thin portion 90a. However, when a plurality of thin portions 90a are provided, they serve to disperse the load applied by external force, resulting in extremely lowered incidence of cracks within the thin portions 90a and extremely lowered incidence of breaks within the sealed portion 8.

Furthermore, when a plurality of thin portions 90a are provided, unlike the case where only one thin portion 90a is provided, effects to be obtained when the thickness of the heat-sealing layer 5 in the thin portions 90a is increased remains the same. As a result, by increasing the thickness of the heat-sealing layer 5 in the thin portion 90a, a decrease in the strength and the sealing strength of the film laminate is reduced and therefore incidence of cracks within the thin portion 90a and a risk of breaks within the sealed portion 8 can be reduced.

In the method for producing the vacuum insulation panel 1 according to Embodiment 3, the first thermocompression jig having a protrusion with an arched tip is used for thermocompression of the first film laminate 4a. As a result, external force due to pressurization is also applied in the direction vertical to a tangent of the arch of the protrusion 11, and therefore the resin in the heat-sealing layer 5 easily flows in the direction toward the both ends of the thin portion 90a.

Because of this, when preparing the vacuum insulation panel 1 where the thin portion 90a has uniform thickness, temperature conditions and pressure conditions can be relaxed compared to the case where a flat surface as that of the sealing jig 106 disclosed in PTL 1 is used for compression. As a result, degradation of the first film laminate 4a and the second film laminate 4b can be reduced.

In other words, the thickness of the thin portion 90a of the heat-sealing layer 5 can be further reduced without changing the conditions during formation and, as a result, the amount of gas and moisture entering from the end face of the first film laminate 4a or the second film laminate 4b is reduced more easily.

### Embodiment 4

A heat-insulating box according to Embodiment 4 includes: at least one vacuum insulation panel according to any one of Embodiments 1 to 3, an outer casing, and an inner casing, in which the non-joining side of the first film laminate or the second film laminate of the vacuum insulation panel is fixed to a surface of the inner casing, the surface facing the outer casing, and a gap between the outer casing and the inner casing except for where the vacuum insulation panel is provided is filled with a foam insulating material.

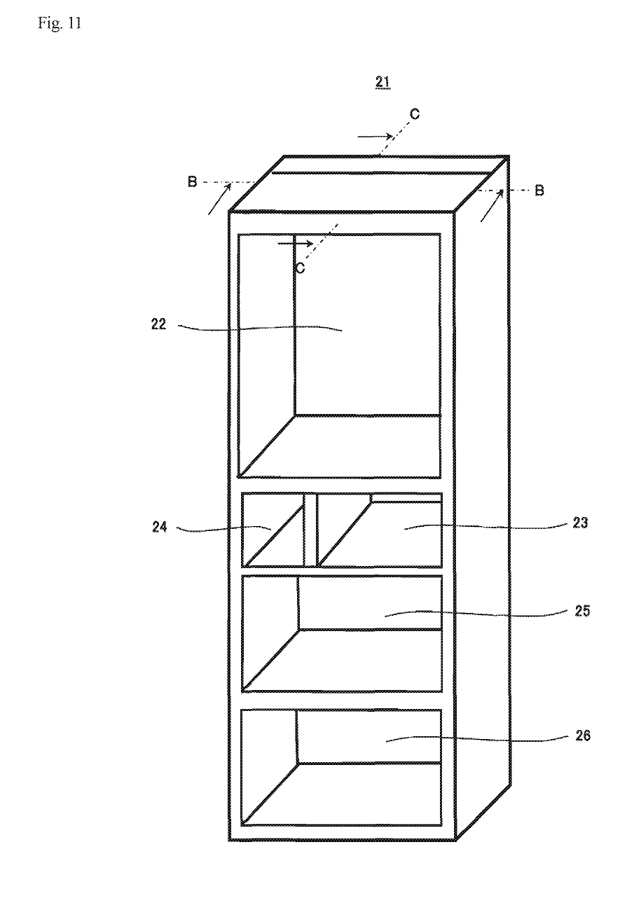

The following describes an example of the heat-insulating box according to Embodiment 4, with reference to FIG. 11 to FIG. 13.

Configuration of Heat-Insulating Box

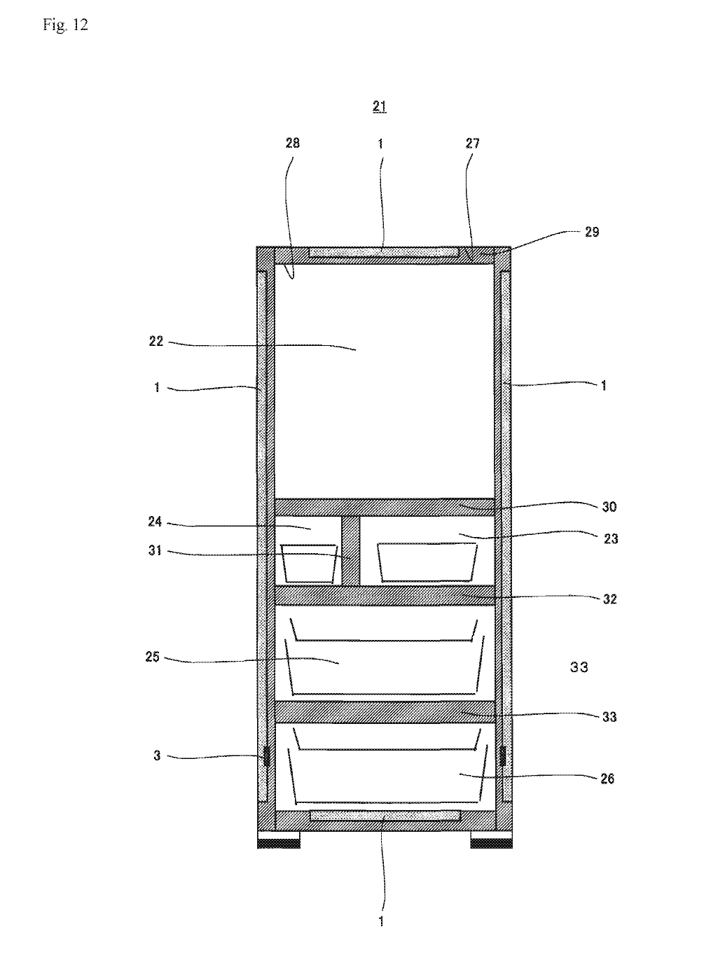

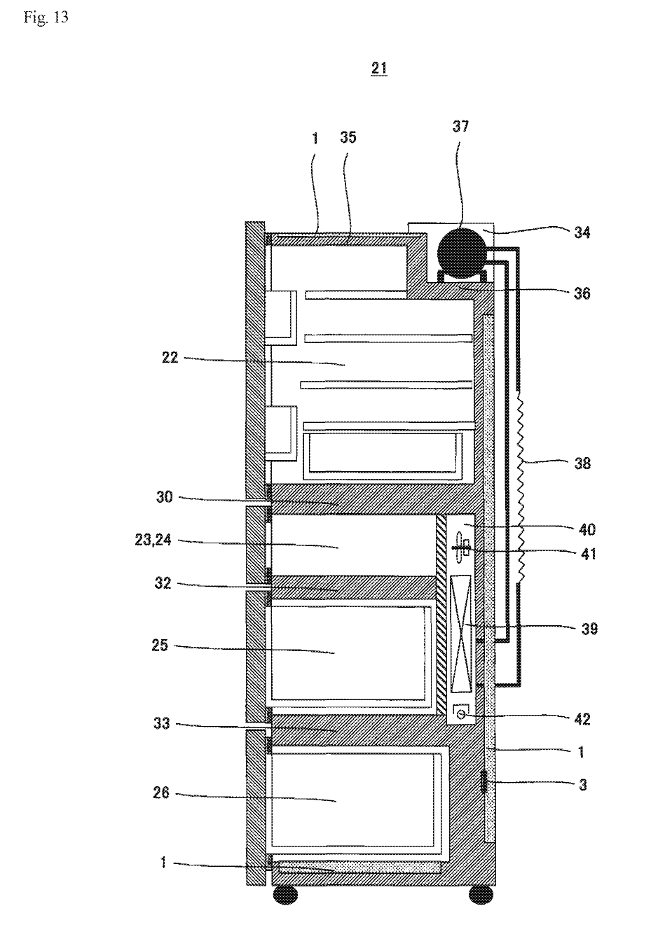

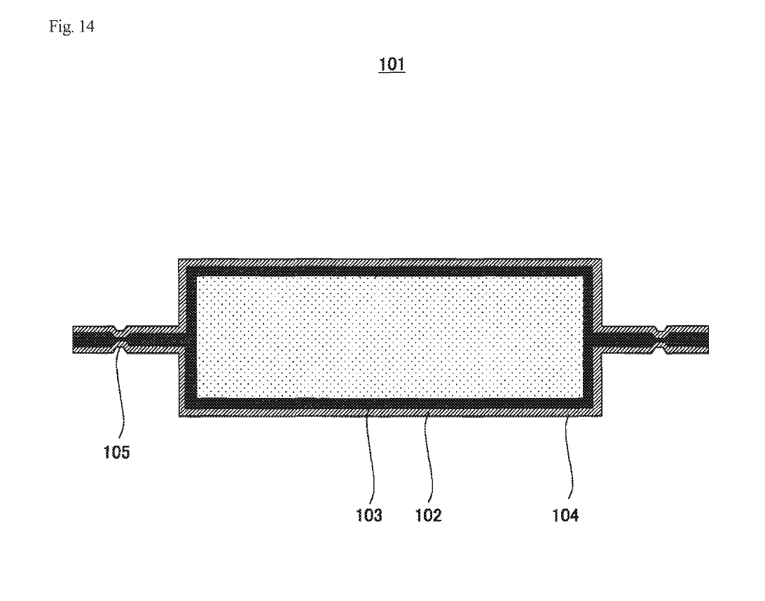

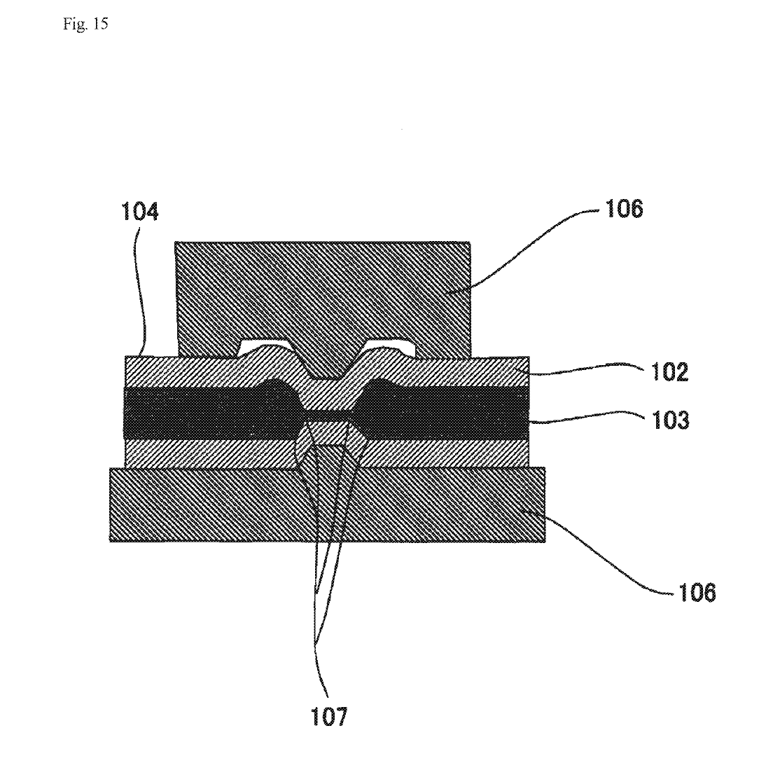

FIG. 11 is a schematic perspective view of the configuration of a heat-insulating box according to Embodiment 4. FIG. 12 is a sectional view taken from line B-B of FIG. 11. FIG. 13 is a sectional view taken from line C-C of FIG. 11.

As shown in FIG. 11 to FIG. 13, a heat-insulating box 21 according to Embodiment 4 includes at least one vacuum insulation panel 1 according to any one of Embodiments 1 to 3, an outer casing 27 made of metal (an iron plate or a steel plate, for example) having an opening in the front, an inner casing 28 made of a rigid resin (ABS, for example), and a foam insulating material 29 that has been applied as foam to fill the gap between the outer casing 27 and the inner casing 28.

The vacuum insulation panels 1 are affixed to and in contact with the inner sides of the top surface, the back surface, the left surface, and the right surface of the outer casing 27 and affixed to and in contact with the bottom surface of the inner casing 28. A gas adsorbent in the vacuum insulation panels 1 is positioned closer to the exterior (or closer to the side of the outer casing) than to the center of the box.

The space within the heat-insulating box 21 is divided into a plurality of storage compartments by a first heat-insulating divider 30 to a fourth heat-insulating divider 33. Specifically, a refrigerator compartment 22 is provided at the top of the heat-insulating box 21 and, below the refrigerator compartment 22, an upper freezer compartment 23 and an ice compartment 24 are provided adjacent to each other. The first heat-insulating divider 30 is provided so as to divide the refrigerator compartment 22 from the upper freezer compartment 23 and the ice compartment 24, while a second heat-insulating divider 31 is provided so as to divide the upper freezer compartment 23 from the ice compartment 24.

A lower freezer compartment 25 is provided below the upper freezer compartment 23 and the ice compartment 24 and, below the lower freezer compartment 25, a vegetable compartment 26 is provided. A third heat-insulating divider 32 is provided so as to divide the upper freezer compartment 23 and the ice compartment 24 from the lower freezer compartment 25, while the fourth heat-insulating divider 33 is provided so as to divide the lower freezer compartment 25 from the vegetable compartment 26.

The second heat-insulating divider 31 and the third heat-insulating divider 32 are parts that are assembled after the foam insulating material 29 is applied as foam to fill the gap between the outer casing 27 and the inner casing 28, and therefore the insulating material used in the dividers is, but is not limited to, polystyrene foam. For example, from the viewpoint of improving insulation and rigidity, the foam insulating material 29 may be used. Alternatively, from the viewpoints of improving insulation and rigidity so as to achieve further reduction of the thickness of the dividers, for example, the vacuum insulation panel 1 according to any one of Embodiments 1 to 4 may be used.

By reducing the thickness of or removing the second heat-insulating divider 31 and the third heat-insulating divider 32 while leaving space for a door frame to operate, a cooling air duct can be provided so as to achieve improvement in the cooling capacity of the heat-insulating box 21. By hollowing the second heat-insulating divider 31 and the third heat-insulating divider 32 to form them into cooling air ducts, usage of material is reduced.

Each of the upper freezer compartment 23, the ice compartment 24, the lower freezer compartment 25, and the vegetable compartment 26 has a drawer-type door (not shown) with a rail or the like. The front surface of the refrigerator compartment 22 has a set of double doors (not shown), for example.

For preservation by refrigeration, the temperature inside the refrigerator compartment 22 is usually set at 1 to 5° C., with the lower limit to the temperature being the temperature at which food and the like do not freeze. The temperature inside the vegetable compartment 26 is often set at 2° C. to 7° C., which is equivalent to or slightly higher than the temperature inside the refrigerator compartment 22. At a low temperature, leafy vegetables can remain fresh for an extended period of time. For preservation by freezing, the temperature inside the upper freezer compartment 23 and the lower freezer compartment 25 is usually set at −22 to −18° C. In order to improve the state of preservation by freezing, the temperature is sometimes set at as low as −30 to −25° C., for example.

The temperature inside the refrigerator compartment 22 and the vegetable compartment 26 is set at a temperature equal to or above zero, which is called a cooling temperature range. The temperature inside the upper freezer compartment 23, the lower freezer compartment 25, and the ice compartment 24 is set at a temperature below zero, which is called a freezing temperature range. The upper freezer compartment 23 may serve as a changing compartment where the temperature can be selected from the cooling temperature range and the freezing temperature range.

As shown in FIG. 12, a top surface part of the heat-insulating box 21 has surfaces at step-wise heights decreasing toward the back surface of the heat-insulating box 21, namely, a first top surface part 35 and a second top surface part 36. On the second top surface part 36, a machine chamber 34 is provided so as to accommodate parts (devices), such as a compressor 37 and a dryer (not shown) for moisture removal, for establishing a cooling cycle system.

The cooling cycle system is established by the compressor 37, the dryer, a capacitor (not shown), a heat dissipation pipe to dissipate heat, a capillary tube 38, and a condenser 39. The cooling cycle system includes a cooling medium enclosed therein for cooling operation. As the cooling medium, a combustible cooling medium is often used in recent years for environmental protection. When the cooling cycle system includes a three-way valve or a changeover valve therein, such functional parts may be accommodated in the machine chamber 34.

On the back surface of the heat-insulating box 21, a cooling chamber 40 that extends vertically is provided. Specifically, the cooling chamber 40 is positioned behind the upper freezer compartment 23, the ice compartment 24, and the lower freezer compartment 25. The cooling chamber 40 accommodates the condenser 39 that has a finned tube configuration and generates cool air. As the material of the condenser 39, aluminum or copper is used.

Near the condenser 39 (in the space above the condenser 39, for example), a cool-air fan 41 is provided for sending, through forced convection, cool air generated by the condenser 39 to the storage compartments, namely, the refrigerator compartment 22, the upper freezer compartment 23, the ice compartment 24, the lower freezer compartment 25, and the vegetable compartment 26.

In the space below the condenser 39, a radiation heater 42 formed of a glass tube is provided. The radiation heater 42 functions as a defrosting device for removing frost that adheres to the condenser 39 or the cool-air fan 41 during cooling operation. The defrosting device is not particularly limited to a radiation heater and may be a heating pipe provided in intimate contact with the condenser 39.

The cool-air fan 41 may be provided directly on the inner casing 28, but this arrangement is not limitative. For example, by providing the cool-air fan 41 on the second heat-insulating divider 31 that is assembled after foam application and subsequently assembling blocks of parts, production cost can be reduced.

Next, cooling of the heat-insulating box 21 is described. The operation of the compressor 37 is controlled by a controller, which is not shown in drawings.

To begin with, when external air enters the refrigerator compartment 22 or the like due to the opening and closing of a door, for example, and the temperature inside the heat-insulating box 21 rises to increase the temperature of a freezer compartment sensor (not shown) to above a start temperature, the compressor 37 starts to operate and initiates cooling operation.

While traveling, particularly within the heat dissipation pipe on the outer casing 27, the cooling medium at a high temperature and under high pressure discharged from the compressor 37 exchanges heat with air outside the outer casing 27 and with the foam insulating material 29 inside the heat-insulating box 21 and becomes cooled into liquid before it arrives at its destination that is a dryer (not shown) provided in the machine chamber 34. The resulting cooling medium as liquid is then fed into the capillary tube 38.

After being fed into the capillary tube 38, the cooling medium is depressurized within the capillary tube 38. The cooling medium then flows into the condenser 39 where the cooling medium exchanges heat with air surrounding the condenser 39 and vaporizes. This cools the air surrounding the condenser 39, and the resulting cool air (cooled air) is fed into the refrigerator compartment 22 and the like by the action of the cool-air fan 41 to cool the interior of the heat-insulating box 21.

The cooling medium thus vaporized returns to the compressor 37 to be compressed within the compressor 37 and is then discharged from the compressor 37 to circulate in the cooling cycle system. When the interior of the heat-insulating box 21 is cooled and the temperature of the freezer compartment sensor (not shown) is decreased to a temperature equal to or lower than a terminate temperature, the compressor 37 terminates its operation.

The heat-insulating box 21 according to Embodiment 4 having such a configuration includes the vacuum insulation panel 1 according to any one of Embodiments 1 to 3, and therefore has the same effects as the effects of the vacuum insulation panel 1 according to any one of Embodiments 1 to 3.

From the foregoing descriptions, many modifications and other embodiments of the present invention will be apparent to a person skilled in the art. Therefore, the foregoing descriptions should be construed as illustrative only, and have been provided for the purpose of teaching the best mode for carrying out the present invention to a person skilled in the art. Details of the structure and/or function of the present invention may be substantially changed without departing from the essential matters of the present invention. In addition, appropriate combinations of a plurality of the components disclosed in the embodiments above can form various inventions.

### INDUSTRIAL APPLICABILITY

The vacuum insulation panel, the heat-insulating box including the vacuum insulation panel, and the method for producing a vacuum insulation panel of the present invention can improve sealing properties to resist foreign matter and gas barrier properties and therefore are useful for refrigerators and in other fields.

### REFERENCE SIGNS LIST

1 vacuum insulation panel

2 core material

3 adsorbent

4a first film laminate

4b second film laminate

5a first heat-sealing layer

5b second heat-sealing layer

6a gas barrier layer

6b gas barrier layer

7 heat-sealing layer

7a surface protective layer

7b surface protective layer

8 sealed portion

9a first concave portion

9b second concave portion

10 first thermocompression jig

11 protrusion

12 silicon rubber heater

20 inner circumference

21 heat-insulating box

22 refrigerator compartment

23 upper freezer compartment

24 ice compartment

25 lower freezer compartment

26 vegetable compartment

27 outer casing

28 inner casing

29 foam insulating material

30 first heat-insulating divider

31 second heat-insulating divider

32 third heat-insulating divider

33 fourth heat-insulating divider

34 machine chamber

35 first top surface part

36 second top surface part

37 compressor

38 capillary tube

39 condenser

40 cooling chamber

41 cool-air fan

42 radiation heater

51a non-joining side

51b non-joining side

70a film

70b film

71a film

71b film

80b base material

81b base material

90a thin portion

90b deposited film

91b deposited film

101 vacuum heat-insulating panel

102 gas barrier layer

103 adhesive layer

104 outer skin member

105 thinned streak

106 sealing jig

107 sharp edge

1. A vacuum insulation panel comprising:
a core material containing an inorganic fiber,
a first film laminate having a first heat-sealing layer on a joining side, and
a second film laminate having a second heat-sealing layer on a joining side,
the density of the first heat-sealing layer being lower than the density of the second heat-sealing layer.

2. The vacuum insulation panel according to claim 1, wherein the first film laminate comprises metal foil and the second film laminate comprises a deposited film.

3. The vacuum insulation panel according to claim 1, further comprises:
a sealed portion including a heat-sealing layer formed through heat sealing of a joining side of a peripheral portion of the first heat-sealing layer with a joining side of a peripheral portion of the second heat-sealing layer, so that the core material is hermetically enclosed under reduced pressure, wherein
the sealed portion has a corrugated shape with the ridge height of a non joining side of the first heat-sealing layer being greater than the ridge height of a non joining side of the second heat-sealing layer, and the sealed portion includes a first concave portion depressed in the direction from the first film laminate toward the second film laminate and a second concave portion depressed in the direction from the second film laminate toward the first film laminate,
a most-depressed portion of the first concave portion comprises a thin portion where the heat-sealing layer is thinner than the heat-sealing layer surrounding the most-depressed portion, and
the first concave portion and the second concave portion are arranged not to face each other.

4. The vacuum insulation panel according to claim 1, further comprising a gas adsorbent in the interior of the vacuum insulation panel.

5. A heat-insulating box comprising:
the vacuum insulation panel according to claim 1,
an outer casing, and
an inner casing, wherein
the non joining side of the first film laminate or the second film laminate of the vacuum insulation panel is fixed to a surface of the inner casing, the surface facing the outer casing, and
a gap between the outer casing and the inner casing except for where the vacuum insulation panel is provided is filled with a foam insulating material.

6. A method for producing a vacuum insulation panel, comprising:
(A) preparing a first film laminate having a first heat-sealing layer on a joining side and a second film laminate having a second heat-sealing layer on a joining side, the density of the second heat-sealing layer being higher than the density of the first heat-sealing layer,
(B) arranging the first film laminate and the second film laminate so that the joining side of the first film laminate and the joining side of the second film laminate are in contact with each other to prepare a multilayered assembly, and
(C) subjecting at least part of a peripheral portion of the multilayered assembly to thermocompression so as to heat seal the first heat-sealing layer and the second heat-sealing layer together.

7. The method for producing a vacuum insulation panel according to claim 6, wherein
in the step (C), heat and pressure are applied to a non joining side of the first film laminate with a first thermocompression jig having a protrusion with an arched tip and heat and pressure are applied to a non joining side of the second film laminate with a second, platy thermocompression jig, so as to heat seal the first heat-sealing layer and the second heat-sealing layer together and form a sealed portion into a corrugated shape.

8. The method for producing a vacuum insulation panel according to claim 6, wherein
the step (C) comprises:
(C1) applying heat and pressure to the non joining side of the first film laminate and the non joining side of the second film laminate with a pair of platy thermocompression jigs so as to heat seal the first heat-sealing layer and the second heat-sealing layer together, and
(C2) applying heat and pressure to the non joining side of the first film laminate with the first thermocompression jig having a protrusion with an arched tip and applying heat and pressure to the non joining side of the second film laminate with the second platy thermocompression jig, so as to form the sealed portion into a corrugated shape.
